(19) United States
(12) Patent Application Publication
(10) Pub. No.: US 2023/0303105 A1
(43) Pub. Date: Sep. 28, 2023

(54) CONTROL METHOD

(71) Applicant: Panasonic Intellectual Property Management Co., Ltd., Osaka (JP)

(72) Inventors: Hiroshi YAHATA, OSAKA FU (JP); Tomoyuki HIROTA, HYOGO KEN (JP)

(73) Assignee: Panasonic Intellectual Property Management Co., Ltd., Osaka (JP)

(21) Appl. No.: 18/123,757

(22) Filed: Mar. 20, 2023

(30) Foreign Application Priority Data
Mar. 25, 2022 (JP) 2022-050598
Jan. 31, 2023 (JP) 2023-012554

(51) Int. Cl. B60W 50/14; B60W 50/12; B60W 50/08

(52) U.S. Cl. CPC B60W 50/14; B60W 50/12; B60W 50/082; B60W 2050/146; B60W 2540/043; B60W 2540/215; B60W 2556/45

(57) ABSTRACT

A control method is in a system that is communicable with a plurality of terminals via a network and manages a plurality of application candidates for the plurality of terminals. The control method includes: acquiring, via the network, from a first terminal connected to a first vehicle, first request information for requesting first catalog information indicating an application catalog for the first terminal and first level information indicating a level of automatic driving executable by the first vehicle; generating, as the first catalog information, information including one or more first application candidates selected from the plurality of application candidates according to the level of automatic driving executable by the first vehicle, based on the first request information and the first level information; and transmitting, to the first terminal via the network, first display information for displaying the first catalog information on a display of the first terminal.

### CROSS-REFERENCE TO RELATED APPLICATIONS

This application is based upon and claims the benefit of priority from Japanese Patent Application No. 2022-050598, filed on Mar. 25, 2022 and Japanese Patent Application No. 2023-012554, filed on Jan. 31, 2023, the entire contents of which are incorporated herein by reference.

### FIELD

The present disclosure relates to a control method.

### BACKGROUND

JP 2012-226757 A discloses a method for enabling an application installed in an existing mobile terminal to be easily moved and installed in a new mobile terminal.

However, in the related art, a method for installing an application in an in-vehicle terminal has not been studied.

An object of the present disclosure is to further improve installation of an application on an in-vehicle terminal.

### SUMMARY

A control method according to an aspect of the present disclosure is in a system that is communicable with a plurality of terminals via a network and manages a plurality of application candidates for the plurality of terminals. The control method includes: acquiring, via the network, from a first terminal connected to a first vehicle, first request information for requesting first catalog information indicating an application catalog for the first terminal and first level information indicating a level of automatic driving executable by the first vehicle; generating, as the first catalog information, information including one or more first application candidates selected from the plurality of application candidates according to the level of automatic driving executable by the first vehicle, based on the first request information and the first level information; and transmitting, to the first terminal via the network, first display information for displaying the first catalog information on a display of the first terminal.

### BRIEF DESCRIPTION OF THE DRAWINGS

FIG. 1 is a diagram illustrating an example of an overall configuration of an information management system of the present disclosure;

FIG. 2 is a block diagram illustrating an example of an overall configuration of an information management system of the present disclosure;

FIG. 3 is a sequence diagram illustrating an example of processing of the information management system of the present disclosure;

FIG. 4A is a flowchart illustrating an example of processing of the information management system of the present disclosure;

FIG. 4B is a flowchart illustrating an example of processing of the information management system of the present disclosure;

FIG. 4C is a flowchart illustrating an example of processing of the information management system of the present disclosure;

FIG. 5 is a flowchart illustrating an example of processing of the information management system of the present disclosure;

FIG. 6 is a diagram illustrating an example of a data configuration indicating a relationship between a terminal type and an installable application ID in the information management system of the present disclosure;

FIG. 7A is a diagram illustrating an example of a screen displayed on a display of an in-vehicle terminal corresponding to a vehicle whose level of automatic driving is 2 or less in the information management system of the present disclosure;

FIG. 7B is a diagram illustrating an example of a screen displayed on the display of the in-vehicle terminal corresponding to the vehicle whose level of automatic driving is 3 or more in the information management system of the present disclosure;

FIG. 7C is a diagram illustrating an example of a screen displayed on a display of the smartphone in the information management system of the present disclosure;

FIG. 8 is a diagram illustrating an example of a screen displayed on a display of the in-vehicle terminal in the information management system of the present disclosure;

FIG. 9 is a diagram illustrating an example of a screen displayed on a display of the in-vehicle terminal in the information management system of the present disclosure;

FIG. 10 is a diagram illustrating an example of a screen displayed on a display of the in-vehicle terminal in the information management system of the present disclosure;

FIG. 11 is a diagram illustrating an example of a data configuration indicating a list of applications used in a different terminal in the information management system of the present disclosure;

FIG. 12 is a diagram illustrating an example of a data configuration indicating an application installed by each user in the information management system of the present disclosure;

FIG. 13 is a flowchart illustrating an example of processing of the information management system of the present disclosure;

FIG. 14A is a diagram illustrating an example of a screen displayed on the in-vehicle terminal of a user ID1 in the information management system of the present disclosure;

FIG. 14B is a diagram illustrating an example of a screen displayed on the in-vehicle terminal of a user ID2 in the information management system of the present disclosure;

FIG. 15 is a diagram illustrating an example of a data configuration indicating first secret setting information in the information management system of the present disclosure;

FIG. 16 is a flowchart illustrating an example of processing of the information management system of the present disclosure;

FIG. 17A is a diagram illustrating an example of a screen displayed on the in-vehicle terminal in the information management system of the present disclosure;

FIG. 17B is a diagram illustrating an example of a screen displayed on the in-vehicle terminal in the information management system of the present disclosure;

FIG. 18 is a diagram illustrating an example of a data configuration indicating the usage condition information in the information management system of the present disclosure;

FIG. 19 is a flowchart illustrating an example of processing of the information management system of the present disclosure;

FIG. 20A is a diagram illustrating an example of a screen displayed on the in-vehicle terminal in the information management system of the present disclosure;

FIG. 20B is a diagram illustrating an example of a screen displayed on the in-vehicle terminal in the information management system of the present disclosure;

FIG. 21 is a flowchart illustrating an example of processing of the information management system of the present disclosure;

FIG. 22A is a diagram illustrating an example of a screen displayed on the in-vehicle terminal in the information management system of the present disclosure;

FIG. 22B is a diagram illustrating an example of a screen displayed on the in-vehicle terminal in the information management system of the present disclosure;

FIG. 23 is a diagram illustrating an example of a data configuration indicating relationship information in the information management system of the present disclosure; and

FIG. 24 is a flowchart illustrating an example of processing of the information management system of the present disclosure.

### DETAILED DESCRIPTION

The present disclosure can also be implemented as a program that causes a computer to execute each characteristic configuration included in the control method used here, or as a system that operates by the program. Furthermore, it goes without saying that such a computer program can be distributed via a computer-readable non-transitory recording medium such as an SD card or a communication network such as the Internet.

Note that each of the exemplary embodiments described below illustrates a specific example of the present disclosure. Numerical values, shapes, constituent elements, steps, order of steps, and the like shown in the following exemplary embodiments are merely examples, and do not limit the present disclosure. Further, among the constituent elements in the following exemplary embodiments, constituent elements that are not described in independent claims indicating the highest concept are described as arbitrary constituent elements. Further, in all the embodiments, the respective contents can be combined.

Hereinafter, embodiments according to an information management system, a terminal, an information providing method, a control method, a program, and a recording medium of the present disclosure will be described.

### First Embodiment

The first embodiment relates to a screen of an application store that introduces a list of applications that can be installed in a terminal.

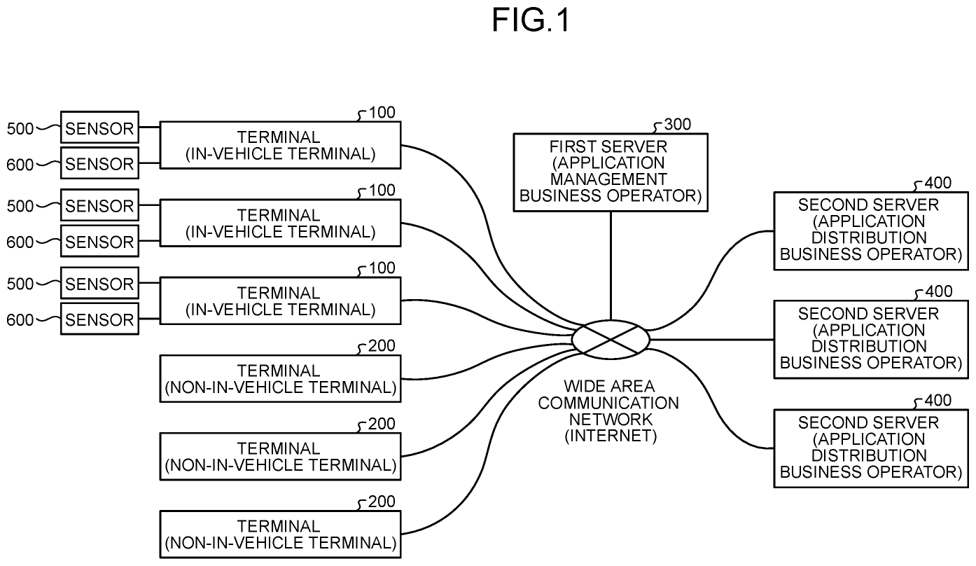

FIG. 1 is a diagram illustrating an example of an overall configuration of an information management system. The information management system in FIG. 1 includes a terminal 100, a terminal 200, a first server 300, a second server 400, a sensor 500, and a sensor 600. The terminal 100, the terminal 200, the first server 300, and the second server 400 are communicably connected to each other via a network.

The terminal 100 is an in-vehicle terminal connected to the vehicle. The terminal 200 is a portable non-in-vehicle terminal such as a smartphone or a tablet terminal. The first server 300 is a server operated by an application management business operator. The second server 400 is a server operated by an application distribution business operator. The sensor 500 is at least one sensor provided in the vehicle compartment of the vehicle. The sensor 600 is at least one sensor provided in the vehicle. The network is a wide area communication network including a mobile phone communication network and the Internet.

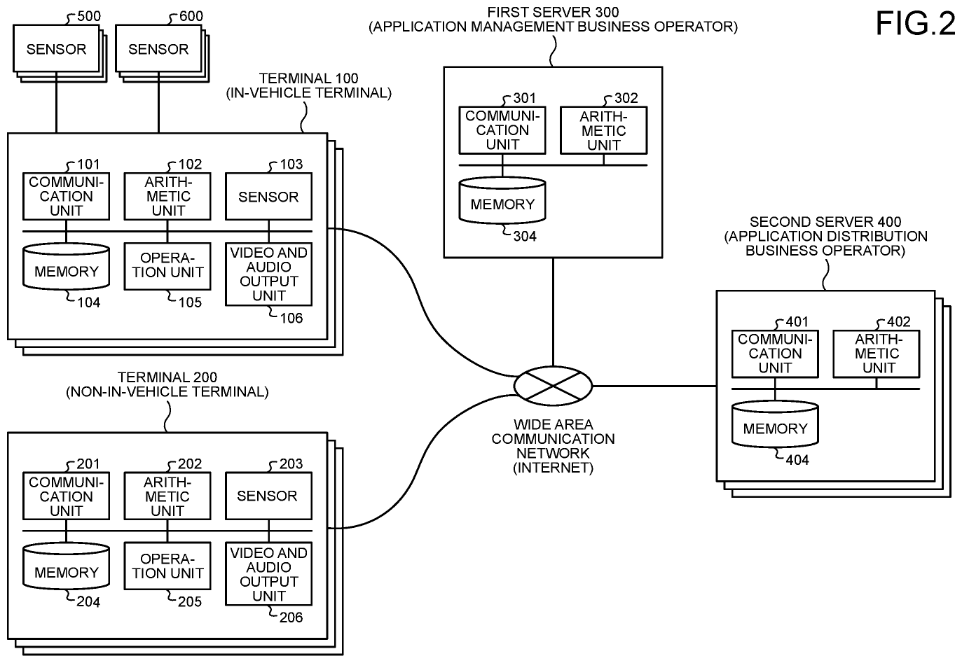

FIG. 2 is a block diagram illustrating an example of an overall configuration of the information management system. The terminal 100 includes a communication unit 101, an arithmetic unit 102, a sensor 103, a memory 104, an operation unit 105, and a video and audio output unit 106. The terminal 200 includes a communication unit 201, an arithmetic unit 202, a sensor 203, a memory 204, an operation unit 205, and a video and audio output unit 206. The first server 300 includes a communication unit 301, an arithmetic unit 302, and a memory 304. The second server 400 includes a communication unit 401, an arithmetic unit 402, and a memory 404.

Each of the communication units 101, 201, 301, and 401 includes a communication circuit. Each of the arithmetic units 102, 202, 302, and 402 includes at least one processor such as a CPU. Each of the sensors 103 and 203 includes an imaging device including a CMOS sensor or the like. The sensor 500 includes an imaging device including a CMOS sensor or the like. The sensor 600 includes, for example, a device capable of acquiring traveling state information indicating a current traveling state of the vehicle. The information acquired by the sensors 500 and 600 is transmitted to the terminal 100 in a wired or wireless manner. The sensor 500 is installed at a position where the occupant can be imaged, for example, on the ceiling in the vehicle compartment. Each of the memories 104, 204, 304, and 404 includes a nonvolatile storage device such as a flash memory. Each of the operation units 105, and 205 includes, for example, an input device such as a touch panel. The video and audio output unit 106, and 206 includes a display, a speaker, and the like.

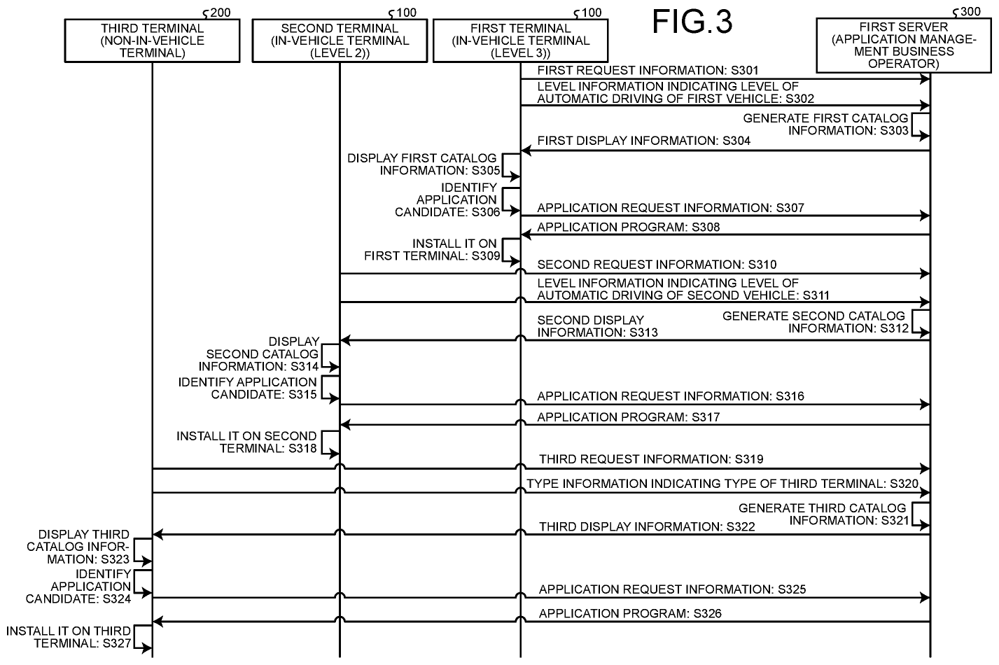

FIG. 3 is a sequence diagram illustrating an example of processing of the information management system.

The first server 300 can communicate with each of a plurality of terminals via a network. The first server 300 manages a plurality of application candidates for a plurality of terminals.

Here, the first terminal 100, the second terminal 100, and the third terminal 200 will be described as an example of the plurality of terminals. The first terminal 100 is an in-vehicle terminal (level 3) connected to the first vehicle. The second terminal 100 is an in-vehicle terminal (level 2) connected to the second vehicle. The third terminal 200 is a non-in-vehicle terminal that is not connected to the vehicle.

Here, in the present disclosure, the in-vehicle terminal (level N) means an in-vehicle terminal mounted on a vehicle when the highest level of automatic driving executable by the vehicle is N. In the present disclosure, the automatic driving level is synonymous with the definition of the automatic driving level defined by the Society of Automotive Engineers. Level 0 corresponds to manned driving, and level 5 corresponds to a fully automatic driving.

The first terminal 100 transmits the first request information to the first server 300 via the network (step S301). The first request information is information for requesting first catalog information indicating an application catalog for the first terminal 100.

In the present disclosure, the application catalog means a list of one or more application programs that can be installed in the terminal. In the present disclosure, an application candidate means an application program included in an application catalog. In the present disclosure, the term application or application may be used synonymously with the term application program.

The first terminal 100 transmits the first level information to the first server 300 via the network (step S302). The first level information is information indicating a level of automatic driving executable by the first vehicle. Note that the first server 300 may acquire the first level information from a database that manages the first level information via a network.

The first server 300 generates the first catalog information based on the first request information and the first level information (step S303). The first catalog information is information including one or more first application candidates selected from a plurality of application candidates according to the level of automatic driving executable by the first vehicle. Each of the one or more first application candidates may be a candidate of an application that is available when the first vehicle is traveling at a level equal to or lower than the highest level of automatic driving executable by the first vehicle or when the first vehicle is stopped. The first server 300 transmits the first display information to the first terminal 100 via the network (step S304). The first display information is information for displaying the first catalog information on the display of the first terminal 100.

Note that, in a case where the first vehicle can execute the automatic driving at a plurality of levels, the first display information may include information for classifying one or more first application candidates into a plurality of groups corresponding to the plurality of levels and displaying the first application candidates on the display. Further, when the automatic driving is executed at the first level for the first application program corresponding to at least one of the one or more first application candidates, the first display information may include information indicating whether the first application program is available.

The first terminal 100 displays the first catalog information on the display of the first terminal 100 (step S305). The first terminal 100 identifies an application candidate selected by the first user from the one or more first application candidates via input to the first terminal 100 by the first user of the first terminal 100 (step S306). The first terminal 100 transmits the application request information to the first server 300 via the network (step S307). The application request information is information for requesting download of an application program corresponding to the identified application candidate.

In a case where the first server 300 receives the application request information about the first terminal 100, it transmits an application program corresponding to the specific application candidate to the first terminal 100 via the network (step S308). Here, the case where the application request information about the first terminal 100 is received is a case where the first server 300 receives selection information indicating that a specific application candidate of the one or more first application candidates is selected by the user in the first terminal 100. In step S308, the first server 300 may transmit an application program corresponding to a specific application candidate to the first terminal 100 via the second server 400 that is an application distribution business operator.

The received application program is installed in the first terminal 100, (step S309).

The second terminal 100 transmits the second request information to the first server 300 via the network (step S310). The second request information is information for requesting second catalog information indicating an application catalog for the second terminal 100. The second terminal 100 transmits the second level information to the first server 300 via the network (step S311). The second level information is information indicating a level of automatic driving executable by the second vehicle. Note that the first server 300 may acquire the second level information from a database that manages the second level information via a network.

The first server 300 generates the second catalog information based on the second request information and the second level information (step S312). The second catalog information is information including one or more second application candidates selected from a plurality of application candidates according to the level of automatic driving executable by the second vehicle. Each of the one or more second application candidates may be an application candidate that is available when the second vehicle is traveling at a level equal to or lower than the highest level of automatic driving executable by the second vehicle or when the second vehicle is stopped. The first server 300 transmits the second display information to the second terminal 100 via the network (step S313). The second display information is information for displaying the second catalog information on the display of the second terminal 100.

In a case where the second vehicle can execute the automatic driving at a plurality of levels, the second display information may include information for classifying one or more second application candidates into a plurality of groups corresponding to the plurality of levels and displaying the classified second application candidates on the display. Further, when the automatic driving is executed at the first level for the second application program corresponding to at least one of the one or more second application candidates, the second display information may include information indicating whether the second application program is available.

The second terminal 100 displays the second catalog information on the display of the second terminal 100 (step S314). The second terminal 100 identifies an application candidate selected by the second user from among one or more second application candidates via input to the second terminal 100 by the second user of the second terminal 100 (step S315). The second terminal 100 transmits the application request information to the first server 300 via the network (step S316).

In a case where the first server 300 receives the application request information about the second terminal 100, it transmits the application program corresponding to the specific application candidate to the second terminal 100 via the network (step S317). Here, the case where the application request information about the second terminal 100 is received is a case where the first server 300 receives selection information indicating that a specific application candidate of the one or more second application candidates is selected in the second terminal 100. In step S317, the first server 300 may transmit an application program corresponding to a specific application candidate to the second terminal 100 via the second server 400 that is an application distribution business operator.

The received application program is installed in the second terminal 100, (step S318).

The third terminal 200 transmits the third request information to the first server 300 via the network (step S319). The third request information is information for requesting third catalog information indicating an application catalog for the third terminal 200. The third terminal 200 transmits the type information to the first server 300 via the network (step S320). The type information is information indicating the type of the third terminal 200, and may include information indicating whether it is an in-vehicle terminal or a non-in-vehicle terminal.

The first server 300 generates the third catalog information based on the second request information and the type information (step S321). The third catalog information is information including one or more third application candidates selected from a plurality of application candidates according to the type of the third terminal 200. The first server 300 transmits the third display information to the third terminal 200 via the network (step S322). The third display information is information for displaying the third catalog information on the display of the third terminal 200.

The third terminal 200 displays the third catalog information on the display of the third terminal 200 (step S323). The third terminal 200 identifies an application candidate selected by a third user from among one or more third application candidates via input to the third terminal 200 by the third user of the third terminal 200 (step S324). The third terminal 200 transmits the application request information to the first server 300 via the network (step S325).

In a case where the first server 300 receives the application request information about the third terminal 200, it transmits the application program corresponding to the specific application candidate to the third terminal 200 via the network (step S326). Here, the case where the application request information about the third terminal 200 is received is a case where the first server 300 receives selection information indicating that a specific application candidate of the one or more third application candidates is selected in the third terminal 200. In step S326, the first server 300 may transmit an application program corresponding to a specific application candidate to the third terminal 200 via the second server 400 that is an application distribution business operator.

The received application program is installed in the third terminal 200, (step S327).

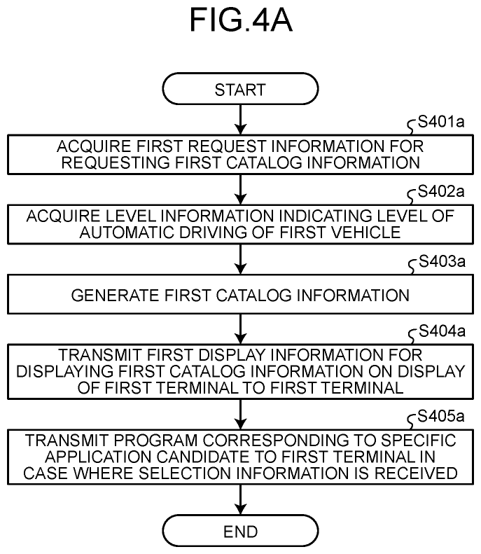

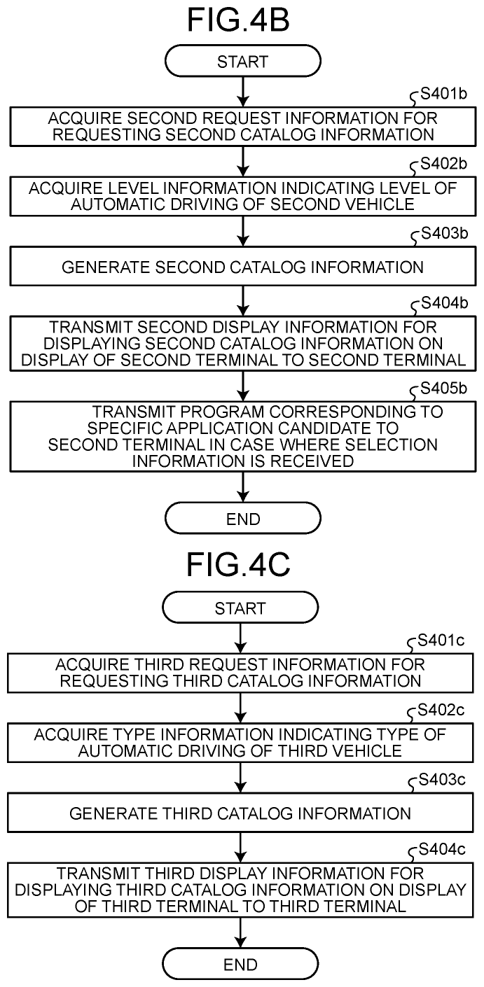

FIG. 4A is a flowchart illustrating an example of processing of the information management system of the present disclosure. FIG. 4A illustrates processing of the first server 300 in the sequence diagram of FIG. 3, particularly, an output to the first terminal 100 based on an input from the first terminal 100.

The first server 300 acquires first request information for requesting first catalog information indicating an application catalog for the first terminal 100 from the first terminal 100 connected to the first vehicle via the network (step S401a). The first server 300 acquires the first level information indicating the level of the automatic driving executable by the first vehicle from the first terminal 100 via the network (step S402a). The first level information may be acquired only when the type information of the first terminal 100 indicates an in-vehicle terminal. That is, the first level information may not be acquired or may be handled as disabled, when the first terminal 100 is a non-in-vehicle terminal. The first server 300 generates, as the first catalog information, information including one or more first application candidates selected from among the plurality of application candidates according to the level of automatic driving executable by the first vehicle based on the first request information and the first level information (step S403a). The first server 300 transmits first display information for displaying the first catalog information on the display of the first terminal 100 to the first terminal 100 via the network (step S404a). When receiving selection information indicating that a specific application candidate of the one or more first application candidates is selected in the first terminal 100, the first server 300 transmits an application program corresponding to the specific application candidate to the first terminal via the network (step S405a). Thereafter, the flow of FIG. 4A ends.

FIG. 4B is a flowchart illustrating an example of processing of the information management system of the present disclosure. FIG. 4B illustrates processing of the first server 300 in the sequence diagram of FIG. 3, particularly, an output to the second terminal 100 based on an input from the second terminal 100.

The first server 300 acquires the second request information for requesting the second catalog information indicating the application catalog for the second terminal 100 from the second terminal 100 connected to the second vehicle via the network (step S401b). The first server 300 acquires the second level information indicating the level of the automatic driving executable by the second vehicle from the second terminal 100 via the network (step S402b). Similarly to the first level information as described above, the second level information may be also acquired only when the second terminal 100 is a in-vehicle terminal. The first server 300 generates, as the second catalog information, information including one or more second application candidates selected from among the plurality of application candidates according to the level of automatic driving executable by the second vehicle based on the second request information and the second level information (step S403b). The first server 300 transmits second display information for displaying the second catalog information on the display of the second terminal 100 to the second terminal 100 via the network (step S404b). Here, in a case where the highest level of automatic driving executable by the second vehicle is different from the highest level of automatic driving executable by the first vehicle, the one or more second application candidates are at least partially different from the one or more first application candidates. When receiving selection information indicating that a specific application candidate of the one or more second application candidates is selected in the second terminal 100, the first server 300 transmits an application program corresponding to the specific application candidate to the second terminal 100 via the network (step S405b). Thereafter, the flow of FIG. 4B ends.

FIG. 4C is a flowchart illustrating an example of processing of the information management system of the present disclosure. FIG. 4C illustrates processing of the first server 300 in the sequence diagram of FIG. 3, particularly, an output to the third terminal 200 based on an input from the third terminal 200.

The first server 300 acquires the third request information for requesting the third catalog information indicating the application catalog for the third terminal 200 from the third terminal 200 via the network (step S401c). The first server 300 acquires type information indicating the type of the third terminal 200 from the third terminal 200 via the network (step S402c). The third terminal 200 is a non-in-vehicle terminal and, for example, a smartphone or a tablet terminal. The first server 300 generates, as third catalog information, information including one or more third application candidates selected according to the type of the third terminal 200 from among the plurality of application candidates based on the third request information and the type information (step S403c). The first server 300 transmits third display information for displaying the third catalog information on the display of the third terminal 200 to the third terminal 200 via the network (step S404c). The one or more third application candidates are at least partially different from the one or more first application candidates and the one or more second application candidates. Thereafter, the flow of FIG. 4C ends.

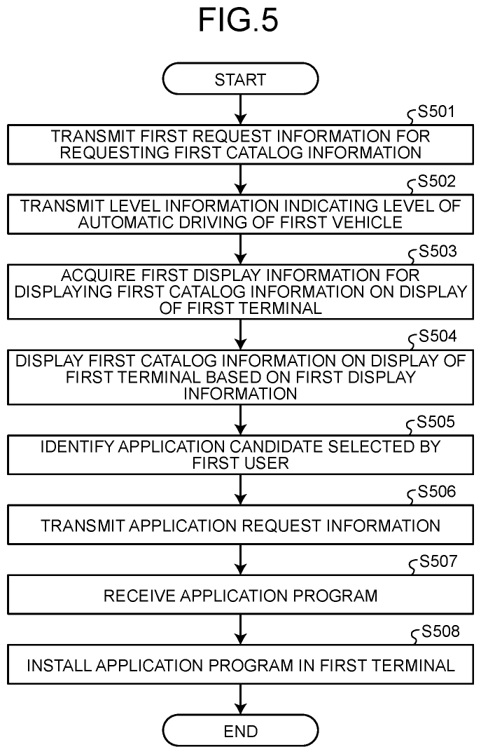

FIG. 5 is a flowchart illustrating an example of processing of the information management system of the present disclosure. FIG. 5 illustrates a method of controlling the first terminal 100 in the sequence diagram of FIG. 3.

In the first terminal 100, the first terminal 100 connected to the first vehicle transmits first request information for requesting first catalog information indicating an application catalog for the first terminal 100 to the first server 300 via the network (step S501). The first terminal 100 transmits first level information indicating a level of automatic driving executable by the first vehicle to the first server 300 via the network (step S502). At this time, the first terminal 100 may transmit, to the first server 300, the type information indicating the type. The first terminal 100 acquires first display information for displaying the first catalog information including one or more first application candidates on the display of the first terminal 100 from the first server 300 via the network (step S503). The one or more first application candidates are selected from a plurality of application candidates in the first server 300 according to the level of automatic driving executable by the first vehicle based on the first level information. The first terminal 100 displays the first catalog information on the display of the first terminal 100 based on the first display information (step S504). The first terminal 100 identifies an application candidate selected by the first user from the one or more first application candidates via input to the first terminal 100 by the first user of the first terminal 100 (step S505). The first terminal 100 transmits application request information for requesting download of an application program corresponding to the identified application candidate to the first server 300 via the network (step S506). The first terminal 100 receives the application program from the first server 300 via the network (step S507). The first terminal 100 installs the received application program on the first terminal 100 (step S508). Thereafter, the flow of FIG. 5 ends.

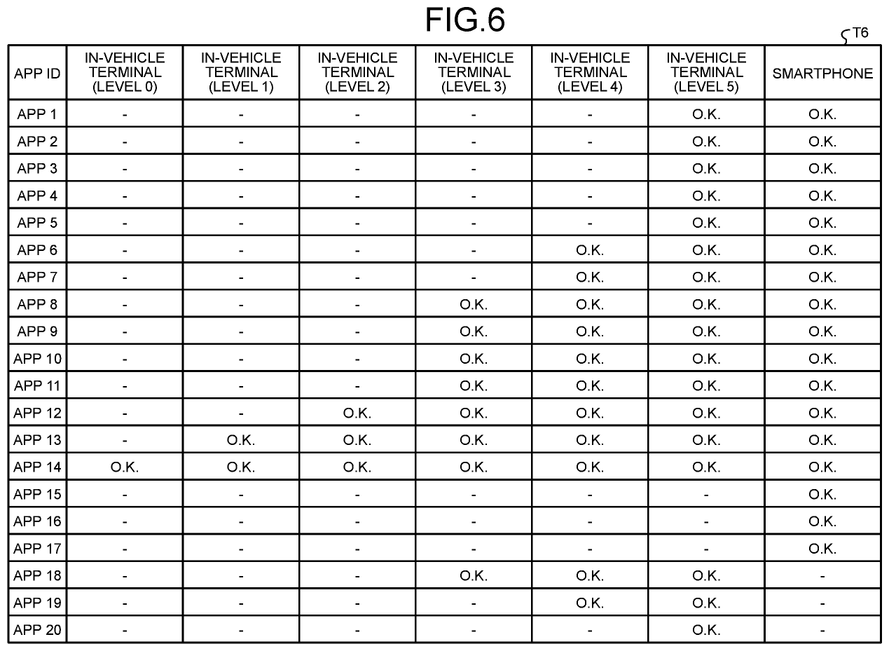

FIG. 6 is a diagram illustrating an example of a data configuration indicating a relationship between a type of a terminal and an installable application ID (app ID). FIG. 6 illustrates a table T6. For example, the table T6 may be used when the first catalog information, the second catalog information, and the third catalog information are generated in the first server 300. In the table T6, an in-vehicle terminal (level N) (N=0 to 5) and a smartphone as a non-in-vehicle terminal are described as the type of terminal. In the Table T6, “APP 1” to “APP 20” are described as the application IDs corresponding to the applications 1 to 20. “O.K.” or “-” in the table T6 means that the application indicated by the application ID is available or unavailable, respectively, in the type of the specific terminal. For example, the table T6 indicates that the applications 6 to 14, 18, and 19 are available for the in-vehicle terminal (level 4).

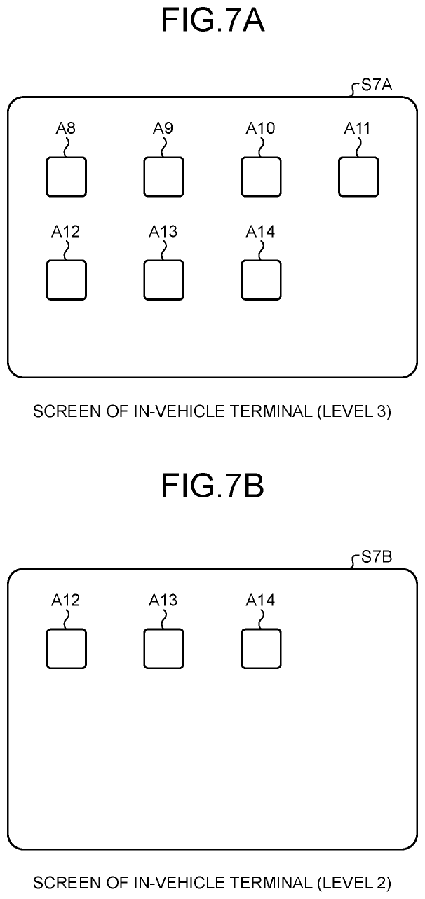

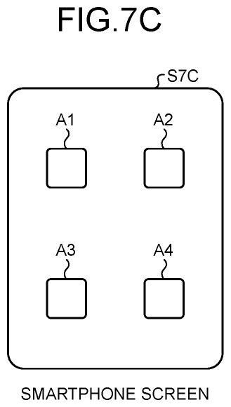

FIG. 7A is a diagram illustrating an example of a screen displayed on the display of the in-vehicle terminal (level 3). FIG. 7B is a diagram illustrating an example of a screen displayed on the display of the in-vehicle terminal (level 2). FIG. 7C is a diagram illustrating an example of a screen displayed on the display of the smartphone.

FIGS. 7A, 7B, and 7C and FIGS. 8, 9, and 11 to be described below correspond to a screen of an application store introducing a list of applications that can be installed in the terminal.

A screen S7A in FIG. 7A is an example of a screen including the first catalog information displayed on the display of first terminal 100 in step S305 in FIG. 3. In this example, the first terminal 100 is an in-vehicle terminal (level 3). In this example, the table T6 in FIG. 6 is used in generating the first catalog information in step S303 in FIG. 3. Icons A8 to A14 indicating that the applications 8 to 14 can be installed, respectively, are displayed on the screen S7A. Here, the applications 8 to 14 are a first application candidate.

A screen S7B in FIG. 7B is an example of a screen including the second catalog information displayed on the display of second terminal 100 in step S314 in FIG. 3. In this example, the second terminal 100 is an in-vehicle terminal (level 2). In this example, the table T6 in FIG. 6 is used in generating the second catalog information in step S312 in FIG. 3. Icons A12 to A14 indicating that the applications 12 to 14 can be installed, respectively, are displayed on the screen S7B. Here, the applications 12 to 14 are a second application candidate.

A screen S7C in FIG. 7C is an example of the screen including the third catalog information displayed on the display of third terminal 200 in step S323 in FIG. 3. In this example, the third terminal 200 is a smartphone. In this example, the table T6 in FIG. 6 is used in generating the third catalog information in step S321 in FIG. 3. Icons A1 to A17 indicating that the applications 1 to 17 can be installed, respectively, are displayed on the screen S7C. Here, the applications 1 to 17 are a third application candidate. Although only the icons A1 to A4 are displayed in FIG. 7C, the remaining icons can be displayed by scrolling the screen S7C.

As illustrated in FIGS. 7A to 7C, only the applications available in each terminal are displayed on each terminal.

According to the above disclosure, a user who uses a terminal can smoothly search for a desired application to be installed while recognizing an application that can be installed for each terminal even in a limited screen area. Therefore, according to the above disclosure, it is possible to realize an information providing system with high operability for the user.

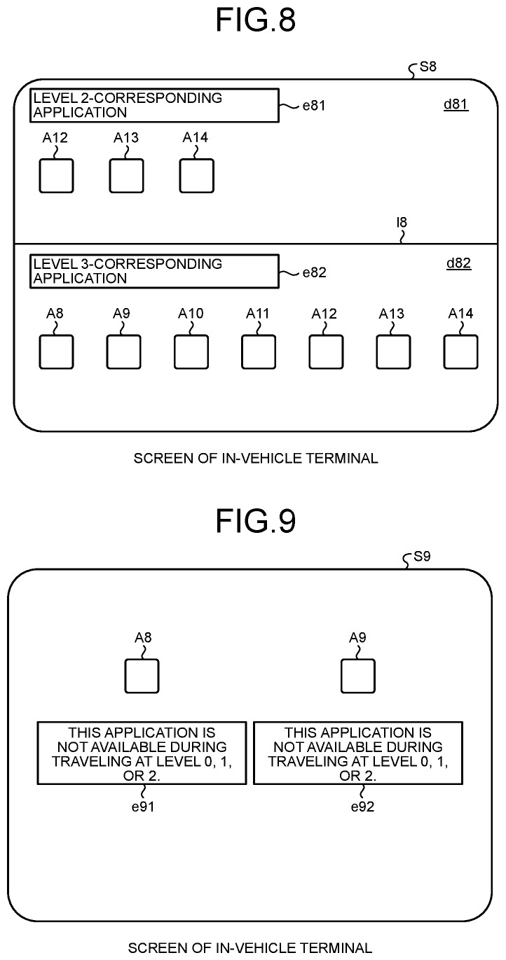

FIG. 8 is a diagram illustrating an example of a screen displayed on the display of the in-vehicle terminal.

A screen S8 in FIG. 8 is another example of the screen including the first catalog information displayed on the display of first terminal 100 in step S305 in FIG. 3. In this example, the first terminal 100 is an in-vehicle terminal (level 3). In this example, the table T6 in FIG. 6 is used in generating the first catalog information in step S303 in FIG. 3. Furthermore, in this example, the level of automatic driving that can be executed by the first vehicle is any of levels 0 to 3. Furthermore, in this example, the first display information transmitted in step S304 in FIG. 3 includes information for classifying one or more application candidates into a plurality of groups corresponding to a plurality of levels and displaying the application candidates on the display.

On a screen S8, a line 18 for dividing the area vertically is displayed. On the screen S8, a description e81 indicating an application corresponding to level 2 is displayed in the upper part of an area d81 above the line 18. On the screen S8, a description e82 indicating an application corresponding to level 3 is displayed in the upper part of an area d82 below the line 18. Note that the line 18 is not essential, but an example for make the display easy to understand.

Icons A12 to A14 indicating that the applications 12 to 14 corresponding to level 2 of the automatic driving can be installed, respectively, are displayed in the area d81. The applications 12 to 14 are a first application candidate.

Icons A8 to A14 (first application candidates) indicating that the applications 8 to 14 corresponding to level 3 of automatic driving can be installed, respectively, are displayed in the area d82. The applications 8 to 14 are a first application candidate.

On the screen S8, the applications corresponding to the levels 2 and 3 are separately shown, but by scrolling the screen S8, it may be possible to display an area in which the applications corresponding to the levels 0 and 1 are separately displayed. Further, applications requiring the higher level than the level 3 of the first terminal 100 may be displayed on the screen S8. In this case, these applications may be allowed to be operated only while the vehicle is stopped or by a passenger who is not involved in driving.

According to the above disclosure, the user who uses the terminal can smoothly search for the desired application to be installed while referring to the information about the application that can be installed for each level of the automatic driving. Therefore, according to the above disclosure, it is possible to realize an information providing system with higher operability for the user.

FIG. 9 is a diagram illustrating an example of a screen displayed on the display of the in-vehicle terminal.

A screen S9 in FIG. 9 is another example of the screen including the first catalog information displayed on the display of first terminal 100 in step S305 in FIG. 3. In this example, the first terminal 100 is an in-vehicle terminal (level 3). In this example, the table T6 in FIG. 6 is used in generating the first catalog information in step S303 in FIG. 3. Furthermore, in this example, the level of automatic driving that can be executed by the first vehicle is any of levels 0 to 3. In this example, the first display information transmitted in step S304 in FIG. 3 includes information indicating whether the first application program is available when the automatic driving is executed at level 1 for the first application program corresponding to at least one of the one or more first application candidates.

Icons A8 and A9 indicating that the applications 8 and 9 can be installed, respectively, are displayed on the screen S9. The applications 8 and 9 are first application candidates. Although only the icons A8 and A9 are displayed in FIG. 9, the remaining icons can be displayed by scrolling the screen S9.

On the screen S9, descriptions e91 and e92 indicating that the application programs cannot be used when the automatic driving is executed at a level 0, 1, or 2 are displayed corresponding to the icons A8 and A9, respectively. Note that the descriptions e91 and e92 may be information indicating whether it is available, information indicating that it is not available, information indicating that it is available, or information indicating whether it is available or not. The descriptions e91 and e92 are an example of information indicating whether the first application program is available when the automatic driving is executed at the first level. Further, the descriptions e91 and e92 may be information indicating a condition under which each application program is available to the driver, or is available to a non-driver. For example, it may be information to the effect that it is available even to the driver while the vehicle is stopped, or information to the effect that it is not available to the driver while driving operation is performed (the vehicle is traveling).

According to the above disclosure, the user who uses the terminal can smoothly search for a desired application to be installed while referring to the information on whether the application program can be used while the vehicle is traveling in the predetermined level of automatic driving. Therefore, according to the above disclosure, it is possible to realize an information providing system with higher operability for the user.

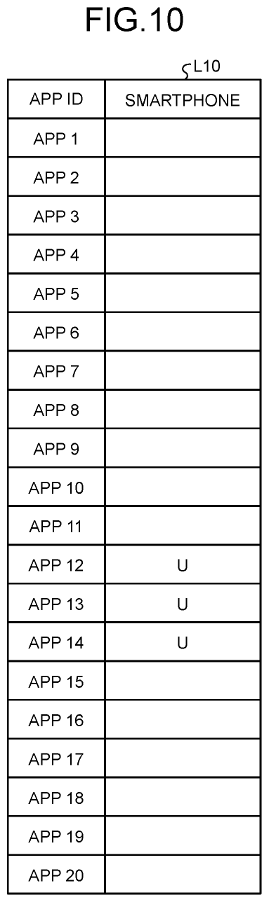

FIG. 10 illustrates an example of a data configuration indicating a list of applications used in a different terminal. FIG. 10 illustrates an application list L10. The application list L10 is a list of applications used by the first user of the first terminal 100 in the different terminal different from the first terminal 100. The application list L10 may be acquired via a network from a database that manages a usage status of a plurality of applications in a plurality of terminals based on a user ID for identifying a first user of the first vehicle to which the first terminal 100 is connected. In the application list L10, a smartphone is described as the different terminal used by the first user. In the application list L10, “APP 1” to “APP 20” are described as application IDs (app IDs) corresponding to the applications 1 to 20. “U” in the application list L10 indicates that the application indicated by the application ID is installed and used in the different terminal that the same user possesses and/or uses. For example, the application list L10 indicates that the applications 12 to 14 are used in the smartphone.

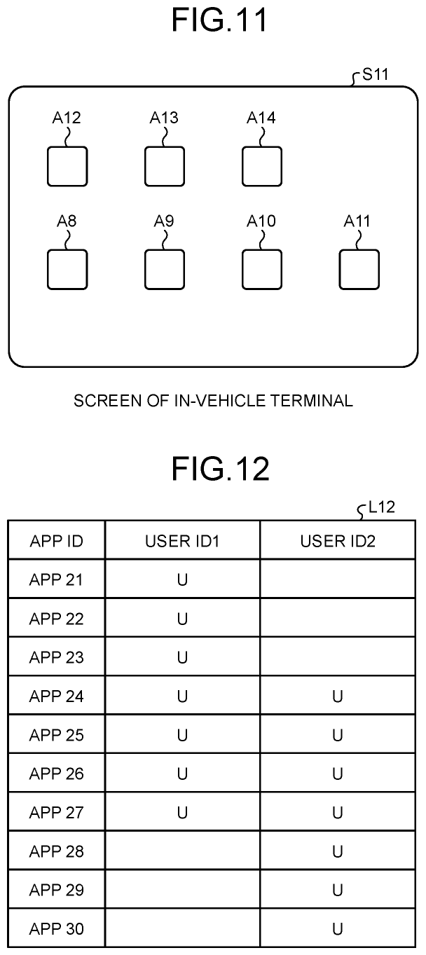

FIG. 11 is a diagram illustrating an example of a screen displayed on the display of the in-vehicle terminal. A screen S11 in FIG. 11 is another example of the screen including the first catalog information displayed on the display of the first terminal 100 in step S305 in FIG. 3. In this example, the first terminal 100 is an in-vehicle terminal (level 3). In this example, the first request information transmitted from the first terminal 100 to the first server 300 includes a user ID for identifying the user of the first vehicle. Further, in this example, the table T6 of FIG. 6 and the application list L10 of FIG. 10 are used in generating the first catalog information in step S303 of FIG. 3. For example, at least one application candidate corresponding to at least one application used by the user in a different computer is identified from among one or more first application candidates based on the application list L10. Furthermore, in this example, the first display information transmitted in step S304 in FIG. 3 includes information for displaying the identified at least one application candidate on the display with priority over the other application candidates.

On the screen S11, icons A8 to A14 indicating that the applications 8 to 14 can be installed, respectively, are shown. Among these, the icons A12 to A14 of the applications 12 to 14 used in the smartphone by the first user of the first terminal 100 are displayed with priority over the other applications, for example, in the display order. Note that the means for preferentially displaying is not limited to the order of displaying. For example, it can be preferentially displayed by a method such as changing the size, color, or shape, adding a special mark, or highlighting the icon with a thick outline. Conversely, icons other than the icon desired to be preferentially displayed may be grayed out.

According to the above disclosure, the user who uses the terminal can smoothly search for a desired application to be installed while referring to an application installed and used in the different terminal of the user, so that an information providing system with high operability for the user can be realized.

### Second Embodiment

The first embodiment relates to a screen of an application store that introduces a list of applications that can be installed in a terminal, whereas the second embodiment relates to a screen for showing a list of applications installed in a terminal to a user.

Hereinafter, the second embodiment will be described. Note that the overall configuration of the information management system of the second embodiment is the same as that of the first embodiment, and thus description thereof is omitted. The same components as those of the first embodiment are denoted by the same reference numerals, and the description thereof will be omitted.

FIG. 12 is a diagram illustrating an example of a data configuration indicating an application installed in the in-vehicle terminal by each user. FIG. 12 illustrates an application list L12. In the application list L12, a first user ID for identifying a first user is associated with a plurality of first application programs available to the first user, and a second user ID for identifying a second user different from the first user is associated with a plurality of second application programs available to the second user. The application list L12 may be acquired via a network from a database that manages a usage status of a plurality of applications in a plurality of terminals.

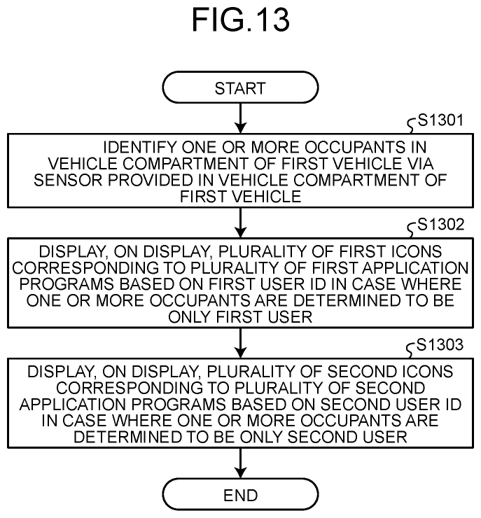

FIG. 13 is a flowchart illustrating an example of processing of the information management system of the present disclosure. FIG. 13 illustrates a method of controlling the first terminal 100 in which a plurality of first application programs available to the first user and a plurality of second application programs available to the second user are stored.

The first terminal 100 identifies one or more occupants in the vehicle compartment of the first vehicle via the sensor 500 provided in the vehicle compartment of the first vehicle (step S1301). When determining that the one or more occupants are only the first user, the first terminal 100 displays a plurality of first icons corresponding to the plurality of first application programs on the display based on the first user ID (step S1302). When determining that the one or more occupants are only the second user, the first terminal 100 displays a plurality of second icons corresponding to the plurality of second application programs on the display based on the second user ID (step S1303). Thereafter, the flow of FIG. 13 ends.

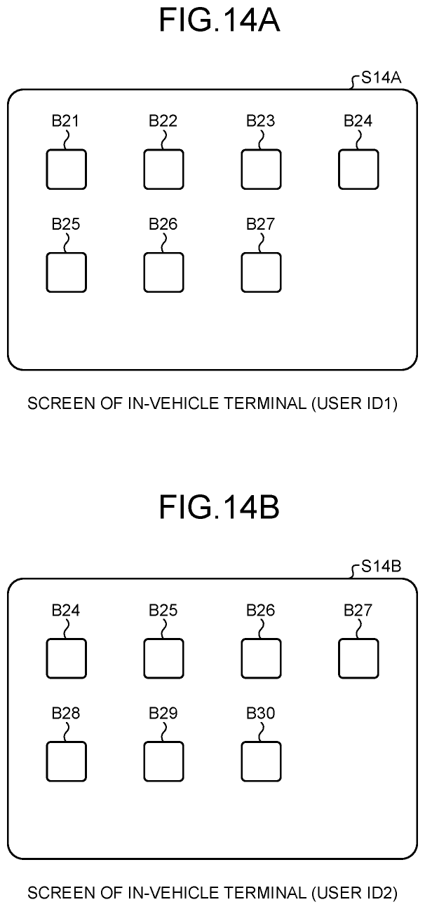

FIG. 14A is a diagram illustrating an example of a screen displayed on the in-vehicle terminal of a user ID1. A screen S14A in FIG. 14A is a screen displayed on the display in step S1202 in FIG. 13. FIG. 14B is a diagram illustrating an example of a screen displayed on the in-vehicle terminal with a user ID2. A screen S14B in FIG. 14B is a screen displayed on the display in step S1203 in FIG. 13.

FIGS. 14A and 14B and FIGS. 17A, 17B, 20A, and 20B described below each correspond to a screen for showing the user a list of applications installed in the terminal.

Icons B21 to B27 indicating that the applications 21 to 27 can be used as the plurality of first application programs available to the first user are displayed on the screen S14A in FIG. 14A. Icons B24 to B30 indicating that the applications 24 to 30 are available as a plurality of second application programs available to the second user are displayed on the screen S14B of FIG. 14B.

According to the above disclosure, in a case where a plurality of people use terminals, according to the user who currently uses the terminal, an application program used by a user can be displayed on the terminal. Therefore, according to the above disclosure, it is possible to realize an information providing system with high operability regardless of the user.

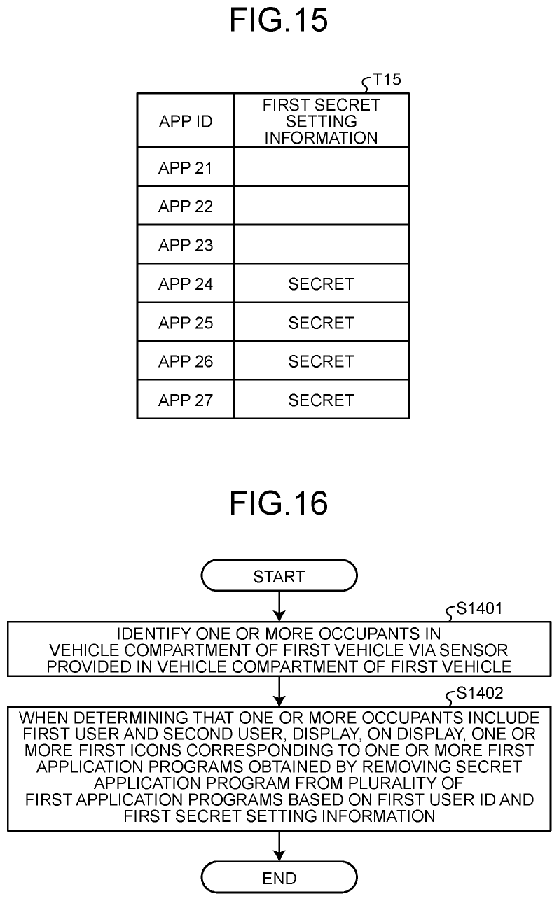

FIG. 15 is a diagram illustrating an example of a data configuration indicating first secret setting information. FIG. 15 illustrates a table T15. In the Table T15, the first secret setting information indicating the secret application program to be kept secret from a user other than the first user among the plurality of first application programs is associated with the first user ID. The table T15 may be acquired from a database that manages the usage status of a plurality of applications in a plurality of terminals via a network. In the Table T15, “secret” indicates a secret application program that should be kept secret from a user other than the first user.

FIG. 16 is a flowchart illustrating an example of processing of the information management system of the present disclosure. FIG. 16 illustrates a method of controlling the first terminal 100 in which a plurality of first application programs available to the first user is stored.

The first terminal 100 identifies one or more occupants in the vehicle compartment of the first vehicle via the sensor 500 provided in the vehicle compartment of the first vehicle (step S1401). When determining that the one or more occupants include the first user and the second user other than the first user, the first terminal 100 displays, on the display, one or more first icons corresponding to the one or more first application programs obtained by removing the secret application program from the plurality of first application programs based on the first user ID and the first secret setting information (step S1402). Thereafter, the flow of FIG. 16 ends.

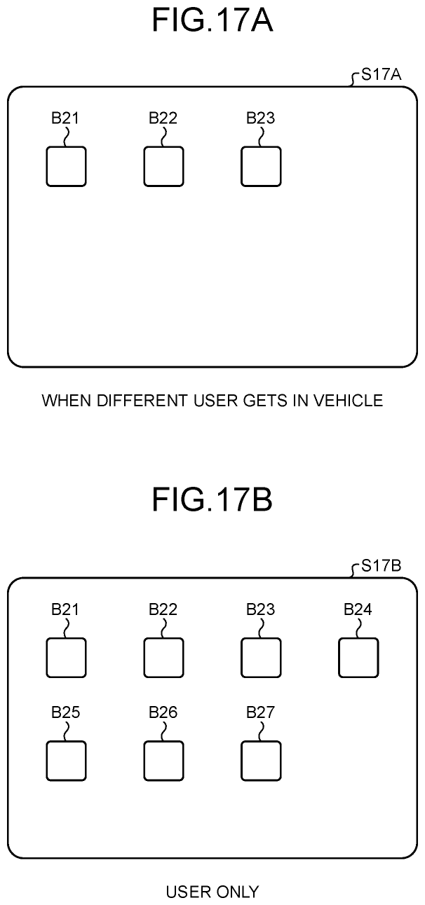

FIG. 17A is a diagram illustrating an example of a screen displayed on the in-vehicle terminal. A screen S17A in FIG. 17A is a screen displayed on the display of the in-vehicle terminal when it is determined in step S1401 in FIG. 16 that one or more occupants include the first user and the second user other than the first user. FIG. 17B is a diagram illustrating an example of a screen displayed on the in-vehicle terminal. A screen S17B in FIG. 17B is a screen displayed on the display of the in-vehicle terminal when it is not determined in step S1401 in FIG. 16 that one or more occupants include the first user and the second user other than the first user, in other words, it is determined that only the first user is in the vehicle.

Icons B21 to B23 indicating that the applications 21 to 23 can be used as a plurality of application programs available to the first user are displayed on the screen S17A in FIG. 17A. On the screen S17A, the icons corresponding to the applications 24 to 27 (see T15 in FIG. 15), which is the secret application programs to be kept secret from a user other than the first user, are not displayed.

On the other hand, on the screen S17B of FIG. 17B, icons B24 to B27 corresponding to the applications 24 to 27 are also displayed as a plurality of application programs available to the first user.

According to the above disclosure, when a different user is in the vehicle, the user who uses the terminal can keep the use of the specific application secret from the different user. Therefore, according to the above disclosure, it is possible to realize an information providing system having high operability for the user while considering privacy.

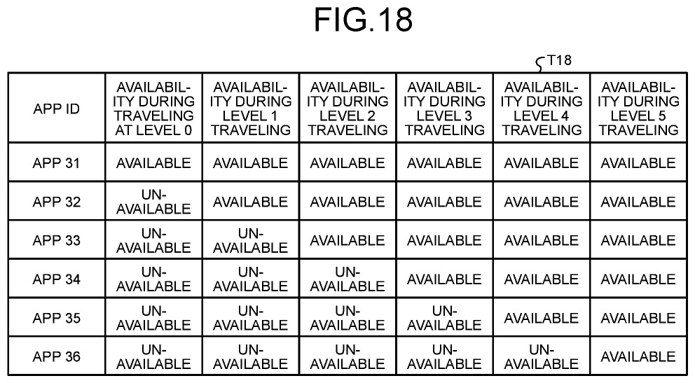

FIG. 18 is a diagram illustrating an example of a data configuration indicating usage condition information. FIG. 18 illustrates a table T18. The Table T18 indicates whether each of the plurality of application programs is available when the vehicle is traveling in the specific level of automatic driving. The table T18 may be acquired from a database that manages the usage status of a plurality of applications in a plurality of terminals via a network. In the table T18, “available” or “unavailable” indicates that the application program is available or unavailable to the driver of the vehicle, respectively, during the traveling at the level N (N=0 to 5). The table T18 may be fully filled with “available” so that all applications are always available to a passenger being a non-driver who is not involved in driving.

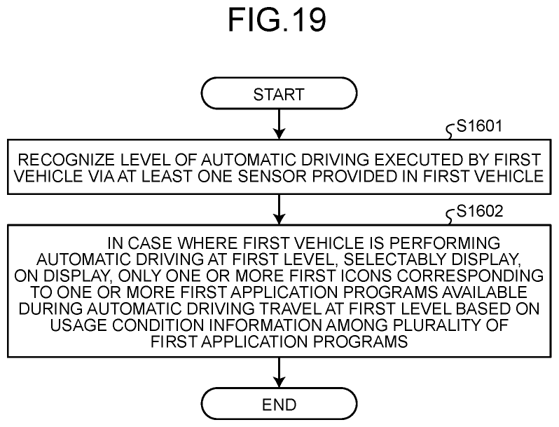

FIG. 19 is a flowchart illustrating an example of processing of the information management system of the present disclosure. FIG. 19 illustrates a method of controlling the first terminal 100 in which a plurality of first application programs available to the first user is stored.

The first terminal 100 recognizes the level of automatic driving executed by the first vehicle via at least one sensor 600 provided in the first vehicle (step S1601). In a case where the first vehicle is performing automatic driving at the first level, the first terminal 100 selectably displays, on the display, or displays as available applications, on the display, only one or more first icons corresponding to one or more first application programs available to the driver during automatic driving travel at the first level based on the usage condition information among the plurality of first application programs (step S1602). Thereafter, the flow of FIG. 19 ends.

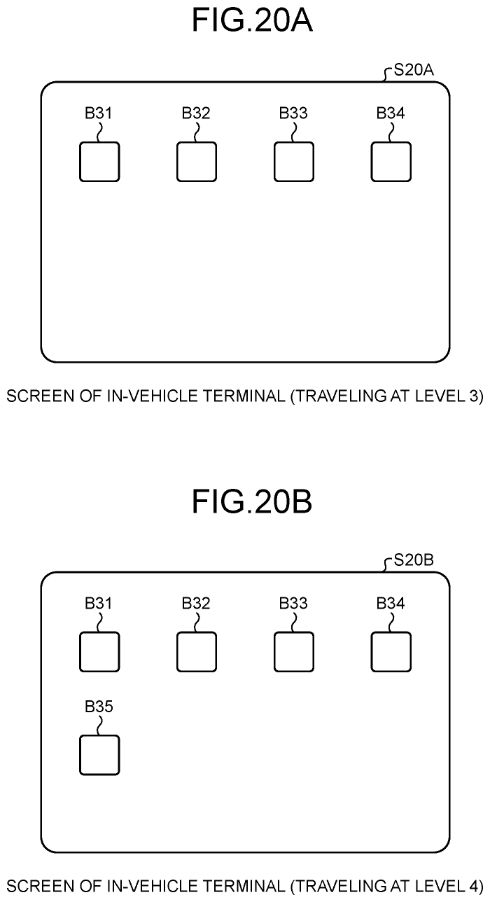

FIG. 20A is a diagram illustrating an example of a screen displayed on the in-vehicle terminal. A screen S20A in FIG. 20A is a screen displayed on the display in step S1602 in FIG. 19 when the vehicle is traveling at level 3 of the automatic driving. FIG. 20B is a diagram illustrating an example of a screen displayed on the in-vehicle terminal. A screen S20B in FIG. 20B is a screen displayed on the display in step S1602 in FIG. 19 when the vehicle is traveling at level 4 of the automatic driving.

On the screen S20A of FIG. 20A, icons B31 to B34 indicating that the applications 31 to 34 can be used as a plurality of application programs that is available while the vehicle on which the first user rides is traveling at level 3 of automatic driving are displayed.

On the screen S20B of FIG. 20B, icons B31 to B35 indicating that the applications 31 to 35 can be used as a plurality of application programs that is available while the vehicle on which the first user rides is traveling at level 4 of the automatic driving are displayed.

As described above, in a case where the vehicle is traveling at the level 4 of the automatic driving, the icon B35 of the application 35 that is not displayed in a case where the vehicle is traveling at the level 3 of the automatic driving is displayed. In an application program that can be used at level 4 or higher of automatic driving as in the application 35, for example, an advertisement such as a commercial message (CM) that is unrelated to driving can be displayed even near the center of the windshield, because the driver does not perform driving. Such an application program may be handled by the in-vehicle computer system as an application program that cannot be activated or used during manned driving at the automatic driving level 3 or during driving at level 2 or less. Further, the attribute information about the application program may be displayed in the application store (see FIGS. 8 and 9).

Note that, in FIG. 20A, the icon B35 of the application 35 is not displayed as the application program that cannot be used during traveling at the level 3 of the automatic driving. However, for example, while the icon B35 of the application 35 is displayed, it may be indicated by another method that the application 35 cannot be used during traveling at the level 3 of the automatic driving. For example, the icon B35 of the application 35 may be grayed out and displayed, or the icon B35 may be annotated (see, for example, descriptions e91 and e92 in FIG. 9.) and displayed during traveling at level 3 of automatic driving.

According to the above disclosure, the user who uses the terminal connected to the vehicle can smoothly search for an installed desired application that is currently executed in the vehicle and that is available according to the level of automatic driving. Therefore, according to the above disclosure, it is possible to realize an information providing system with higher operability for the user.

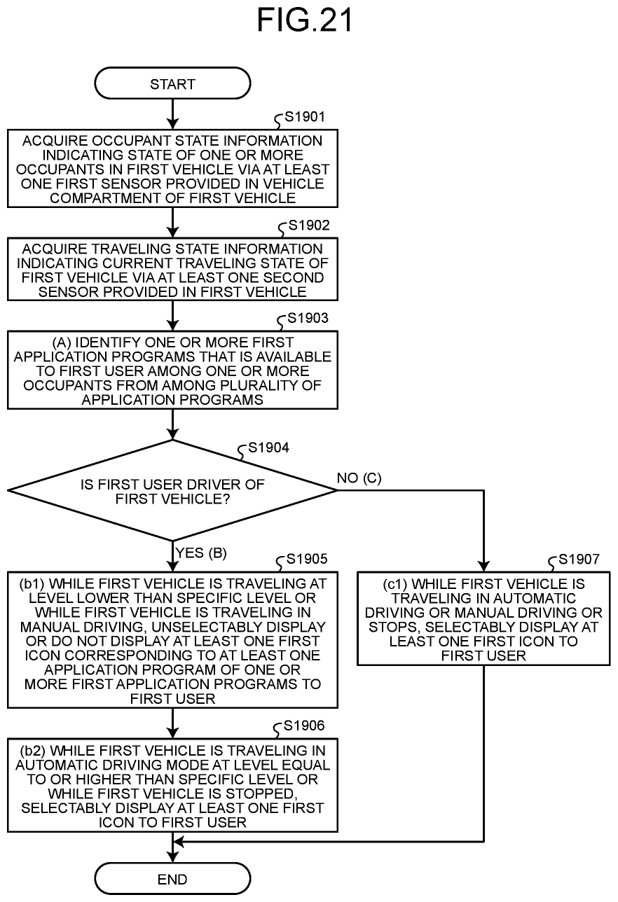

FIG. 21 is a flowchart illustrating an example of processing of the information management system of the present disclosure. FIG. 21 illustrates a method of controlling the first terminal 100 to manage the plurality of application programs and the usage condition information indicating the availability condition of each of the plurality of application programs.

The first terminal 100 acquires occupant state information indicating a state of one or more occupants in the first vehicle via at least one first sensor 500 provided in the vehicle compartment of the first vehicle (step S1901). The first terminal 100 acquires traveling state information indicating the current traveling state of the first vehicle via at least one second sensor 600 provided in the first vehicle (step S1902).

The first terminal 100 executes the following (A) to (C) based on the occupant state information, the traveling state information, and the usage condition information.

(A) The first terminal 100 identifies one or more first application programs that is available to the first user among the one or more occupants from among the plurality of application programs (step S1903). In identifying one or more first application programs available to the first user, for example, a data configuration illustrated in the application list L12 of FIG. 12 may be used.

The first terminal 100 determines whether the first user is a driver of the first vehicle (step S1904).

(B) In a case where the first user is the driver of the first vehicle (step S1904: Yes), the first terminal 100 executes the following (b1) and (b2).

(b1) While the first vehicle is traveling in automatic driving at a level lower than the specific level or while the first vehicle is traveling in manual driving, that is, while the driver lies under the obligation of security, the first terminal 100 unselectably displays or does not display at least one first icon corresponding to at least one application program of one or more first application programs to the first user (step S1905).

(b2) While the first vehicle is traveling in the automatic driving mode at the level equal to or higher than the specific level, that is, while the vehicle system executes automatic driving and the driver does not lie under the obligation of security, or while the first vehicle is stopped, the first terminal 100 selectably displays at least one first icon to the first user (step S1906). Thereafter, the flow of FIG. 21 ends.

On the other hand, (C) in a case where the first user is a passenger other than the driver (step S1904: No), the first terminal 100 executes the following (c1).

(c1) While the first vehicle is traveling in automatic driving or manual driving or stops, the first terminal 100 selectably displays at least one first icon to the first user (step S1907). Thereafter, the flow of FIG. 21 ends.

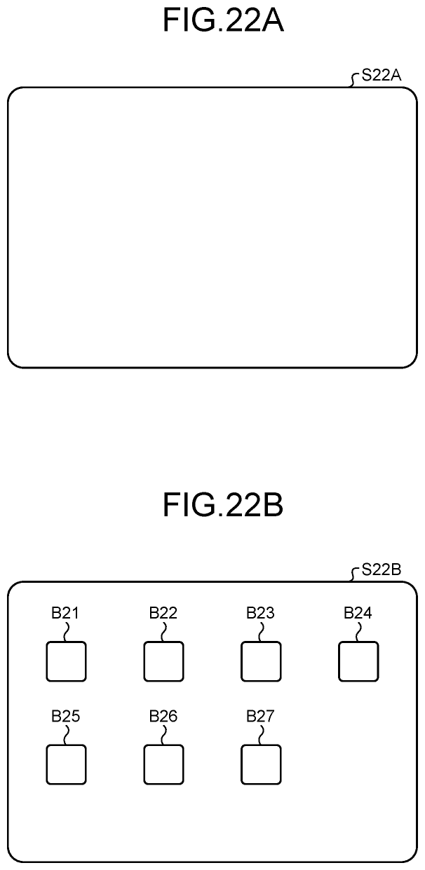

FIG. 22A is a diagram illustrating an example of a screen displayed on the in-vehicle terminal. A screen S22A in FIG. 22A is a screen displayed on the display when the conditions described in step S1905 in FIG. 21 are satisfied. FIG. 22B is a diagram illustrating an example of a screen displayed on the in-vehicle terminal. A screen S22B in FIG. 22B is a screen displayed on the display when the conditions described in step S1906 in FIG. 21 are satisfied or when the conditions described in step S1907 are satisfied.

On the screen S22A of FIG. 22A, no icon indicating the application is displayed. On the other hand, icons B21 to B27 indicating the applications 21 to 27 are displayed on the screen S22B of FIG. 22B. Note that in the case where the applications for which the first user sets the first secret setting information to “secret” are applications 24 to 27, icons B24 to B27 indicating the applications 24 to 27 are not displayed when there is a passenger other than the first user.

According to the above disclosure, availability of the application is determined in consideration of whether the user who uses the terminal is a driver and lies under the obligation of security, whether automatic driving is executed at a predetermined level of automatic driving or higher, and the like. Therefore, according to the above disclosure, it is possible to realize an information providing system having high operability for the user while considering driving safety.

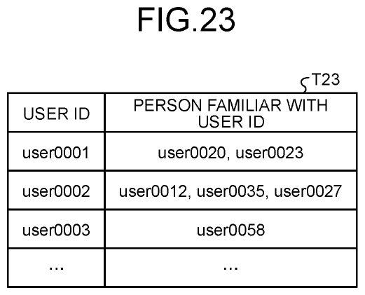

FIG. 23 is a diagram illustrating an example of a data configuration indicating the relationship information. FIG. 23 illustrates a table T23. In the table T23, a relationship between the user and a person familiar with the user is illustrated. The first line of the table T23 indicates that the 20th user whose user ID is identified by the user0020 and the 23rd user whose user ID is identified by the user0023 are persons familiar with the first user whose user ID is identified by the user0001. The same applies to the second and subsequent lines.

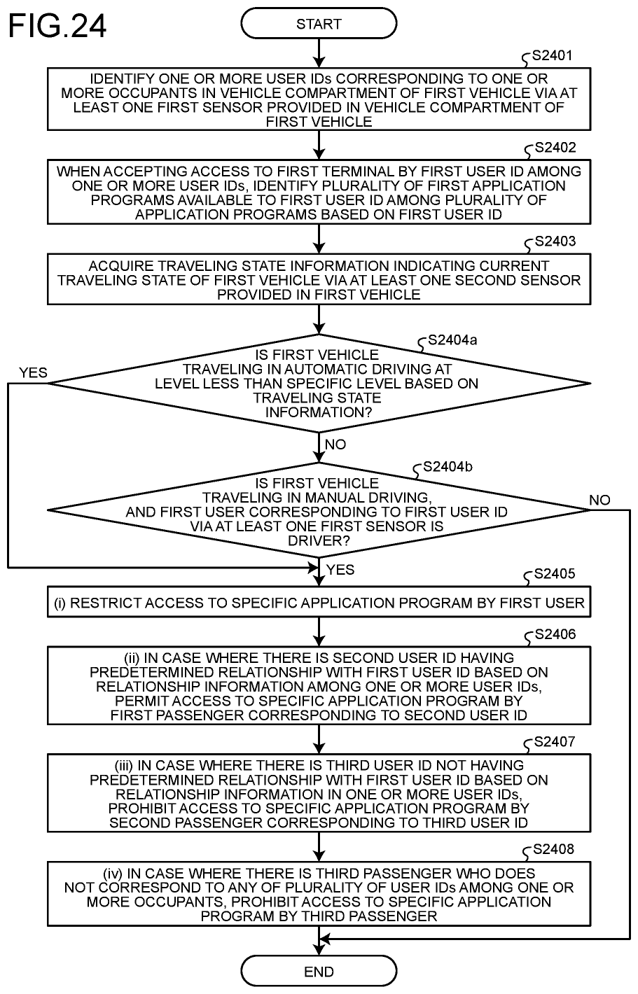

FIG. 24 is a flowchart illustrating an example of processing of the information management system of the present disclosure. FIG. 24 illustrates a method of controlling the first terminal 100 that manages a plurality of user IDs for identifying a plurality of users, relationship information indicating a relationship between the plurality of user IDs, a plurality of application programs, and usage condition information indicating an availability condition for each of the plurality of application programs.

The first terminal 100 identifies one or more user IDs corresponding to one or more occupants in the vehicle compartment of the first vehicle via at least one first sensor 500 provided in the vehicle compartment of the first vehicle (step S2401). When accepting the access to the first terminal 100 by the first user ID among the one or more user IDs, the first terminal 100 identifies a plurality of first application programs available to the first user ID among the plurality of application programs based on the first user ID (step S2402). The first terminal 100 acquires traveling state information indicating the current traveling state of the first vehicle via at least one second sensor 600 provided in the first vehicle (step S2403).

In a case where the first vehicle is traveling in automatic driving at a level lower than the specific level based on the traveling state information (step S2404a: Yes), or in a case where the first vehicle is traveling in manual driving and in a case where it is determined that the first user corresponding to the first user ID is the driver via at least one first sensor 500 (step S2404b: Yes), the first terminal 100 executes the following (i) to (iv) (steps S2405 to S2408) for a specific application program among the plurality of first application programs.

(i) The first terminal 100 restricts access to a specific application program by the first user (step S2405).

(ii) In a case where there is a second user ID having a predetermined relationship with the first user ID based on the relationship information among the one or more user IDs, the first terminal 100 permits access to a specific application program by the first passenger corresponding to the second user ID (step S2406).

(iii) In a case where there is a third user ID that does not have a predetermined relationship with the first user ID based on the relationship information among the one or more user IDs, the first terminal 100 prohibits access to a specific application program by the second passenger corresponding to the third user ID (step S2407).

(iv) In a case where there is a third passenger who does not correspond to any of the plurality of user IDs among one or more occupants, the first terminal 100 prohibits access to a specific application program the third passenger (step S2408).

Thereafter, the flow of FIG. 24 ends. Further, in a case where the first vehicle is not traveling in automatic driving at a level lower than the specific level based on the traveling state information (step S2404a: No), in a case where the first vehicle is not traveling in manual driving, or when it is not determined that the first user corresponding to the first user ID is the driver via at least one first sensor 500 (step S2404b: No), the flow of FIG. 24 ends.

The screen S22A in FIG. 22A corresponds to a screen displayed on the display when the conditions described in step S2405, step S2407, or step S2408 are satisfied. The screen S22B in FIG. 22B corresponds to a screen displayed on the display when the condition described in step S2406 is satisfied.

According to the above disclosure, availability of the application is determined in consideration of whether the user who uses the terminal is a driver, whether automatic driving is being executed at a predetermined automatic driving level or higher, whether a person having a predetermined relationship with the user is riding together, or the like. Therefore, according to the above disclosure, it is possible to realize an information providing system having high operability for the user while considering driving safety and a reliability relationship with passengers.

As in the third terminal 200, the first terminal 100 and the second terminal 100 may display a screen of an application store introducing not only the information indicating the level of the automatic driving but also a list of applications that can be installed based on the type of terminal.

That is, in FIG. 4A, FIG. 4B, or FIG. 4C, in step S402a, step S402b, or step S402c, the first server 300 may acquire information indicating the types of the terminal 100 and 200.

In addition, the table T6 of FIG. 6 may have a data configuration indicating a relationship between the type of the information terminal, such as whether the information terminal is an in-vehicle terminal or a non-in-vehicle terminal such as a smartphone, and an application ID that can be installed.

In addition, the screen S7A of FIG. 7A and the screen S7B of FIG. 7B may have different user interfaces such as the content of the application according to the type of the information terminal.

The present invention may have a configuration in which an application installed in the terminal associated with the user ID, that is, only an available application may be installed according to the type of the terminal.

In each of the screen of the application store and the screen for displaying the list of applications installed in the terminal to the user, the order in which the applications are displayed may be different according to at least one of the type of terminal and the user ID.

Note that the determination of “whether A” in the present disclosure may be a determination of “A”, a determination of “not A”, or a determination of “whether A or not”. In addition, the same applies to expressions such as “is performing A?”, “A is performed?”, and “can perform A?”.

According to at least one embodiment described above, it is possible to further improve the installation of the application on the in-vehicle terminal. For example, according to the present disclosure, usability of an in-vehicle terminal can be improved.

(Supplement)

The following technique is disclosed by the above description of the embodiments.

(Item 1)

A control method in a system that is communicable with a plurality of terminals via a network and manages a plurality of application candidates for the plurality of terminals, the control method including:
acquiring, via the network, from a first terminal connected to a first vehicle, first request information for requesting first catalog information indicating an application catalog for the first terminal and first level information indicating a level of automatic driving executable by the first vehicle;
generating, as the first catalog information, information including one or more first application candidates selected from the plurality of application candidates according to the level of automatic driving executable by the first vehicle based on the first request information and the first level information; and
transmitting, to the first terminal via the network, first display information for displaying the first catalog information on a display of the first terminal.

According to the above disclosure, a user who uses a terminal can smoothly search for a desired application to be installed while recognizing an application that can be installed in each terminal even in a limited screen area, so that an information providing system with high operability for the user can be realized.

(Item 2)

The control method according to Item 1, in which
each of the one or more first application candidates is an application candidate available when the first vehicle is traveling at a level equal to or lower than a highest level of automatic driving executable by the first vehicle or when the first vehicle is stopped.

(Item 3)

The control method according to Item 1 or Item 2, further including:
acquiring, via the network, from a second terminal connected to a second vehicle, second request information for requesting second catalog information indicating an application catalog for the second terminal and second level information indicating a level of automatic driving executable by the second vehicle;
generating, as the second catalog information, information including one or more second application candidates selected from the plurality of application candidates according to the level of automatic driving executable by the second vehicle, based on the second request information and the second level information; and
transmitting, to the second terminal via the network, second display information for displaying the second catalog information on a display of the second terminal, in which
the one or more first application candidates and the one or more second application candidates are at least partially different from each other in a case where a highest level of automatic driving executable by the first vehicle is different from a highest level of automatic driving executable by the second vehicle.

(Item 4A)

The control method according to Item 3, further including:
acquiring, from a third terminal that is not connected to the first vehicle and the second vehicle via the network, third request information for requesting third catalog information indicating an application catalog for the third terminal and type information indicating a type of the third terminal;
generating, as the third catalog information, information including one or more third application candidates selected according to a type of the third terminal from the plurality of application candidates based on the third request information and the type information; and
transmitting, to the third terminal via the network, third display information for displaying the third catalog information on a display of the third terminal, in which
the one or more third application candidates are at least partially different from the one or more first application candidates and the one or more second application candidates.

(Item 4B)

The control method according to item 4A, in which
the third terminal is a smartphone or a tablet terminal.

(Item 5)

The control method according to any one of items 1 to 4B, in which
in a case where the first vehicle is capable of performing automatic driving at a plurality of levels, the first display information includes information for classifying the one or more first application candidates into a plurality of groups corresponding to the plurality of levels and displaying the one or more first application candidates on the display.

According to the above disclosure, the user who uses the terminal can smoothly search for the desired application to be installed while referring to the information about the application that can be installed for each level of the automatic driving, so that it is possible to realize the information providing system with high operability for the user.

(Item 6)

The control method according to any one of items 1 to 5, in which
the first display information includes, for a first application program corresponding to at least one of the one or more first application candidates, information indicating whether the first application program is available when the automatic driving is being executed at a first level.

According to the above disclosure, the user who uses the terminal can smoothly search for a desired application to be installed while referring to the information as to whether the application program can be used while the vehicle is traveling in the predetermined level of automatic driving, so that it is possible to realize the information providing system with high operability for the user.

(Item 7)

The control method according to any one of items 1 to 6, in which
the first request information includes a user ID for identifying a user of the first vehicle,
the control method further includes:
   acquiring, via the network, a list of applications used by the user in a different terminal different from the first terminal from a database that manages a usage status of a plurality of applications in the plurality of terminals based on the user ID, and in generating the first catalog information,
in the generating of the first catalog information, at least one application candidate corresponding to at least one application used by the user in the different terminal is identified from the one or more first application candidates, based on the list, and
the first display information includes information for displaying, on the display of the first terminal, the identified at least one application candidate with priority over another application candidate.

According to the above disclosure, the user who uses the terminal can smoothly search for a desired application to be installed while referring to an application installed and used in the different terminal of the user, so that an information providing system with high operability for the user can be realized.

(Item 8)

The control method according to any one of items 1 to 7, further including
in a case where selection information indicating that a specific application candidate of the one or more first application candidates is selected in the first terminal is received, transmitting an application program corresponding to the specific application candidate to the first terminal via the network.

(Item 9)

A control method for a first terminal that is communicable with a computer that manages a plurality of application candidates via a network and is connected to a first vehicle, the control method including:
transmitting, to the computer via the network, first request information for requesting first catalog information indicating an application catalog for the first terminal and first level information indicating a level of automatic driving executable by the first vehicle;
acquiring, from the computer via the network, first display information for displaying, on a display of the first terminal, the first catalog information including one or more first application candidates, the one or more application candidates being selected from the plurality of application candidates in the computer according to the level of automatic driving executable by the first vehicle, based on the first level information; and
displaying the first catalog information on the display of the first terminal based on the first display information.

(Item 10)

The control method according to item 9, in which
each of the one or more first application candidates is an application candidate available when the first vehicle is traveling at a level equal to or lower than a highest level of automatic driving executable by the first vehicle or when the first vehicle is stopped.

(Item 11)

The control method according to item 9 or item 10, in which
in a case where the first vehicle is capable of executing automatic driving at a plurality of levels, in the displaying of the first catalog information, the one or more first application candidates are classified into a plurality of groups corresponding to a plurality of levels and displayed on the display.

(Item 12)

The control method according to any one of items 9 to 11, in which
in the displaying of the first catalog information, for a first application program corresponding to at least one of the one or more first application candidates, information indicating whether the first application program is available when the automatic driving is executed at a first level is displayed on the display.

(Item 13)

The control method according to any one of items 9 to 12, in which
the first request information includes a user ID for identifying a user of the first vehicle, and
in the displaying of the first catalog information, at least one application candidate of the one or more first application candidates is displayed on the display with priority over another application candidate, the at least one application candidate corresponding to at least one application used by the user identified based on the user ID in a different terminal different from the first terminal.

(Item 14)

The control method according to any one of items 9 to 13, including:
identifying, via input to the first terminal by a first user of the first terminal, an application candidate selected by the first user from the one or more first application candidates;
transmitting, to the computer via the network, application request information for requesting download of an application program corresponding to the identified application candidate;
receiving the application program from the computer via the network; and
installing the received application program on the first terminal.

(Item 15)

The control method according to item 14, in which
the first terminal manages a first user ID that identifies the first user and a plurality of first application programs available to the first user in association with each other, and manages a second user ID that identifies a second user different from the first user and a plurality of second application programs available to the second user in association with each other, and
the control method further includes:
   identifying one or more occupants in a vehicle compartment of the first vehicle via a sensor provided in the vehicle compartment of the first vehicle;
   displaying, on the display, a plurality of first icons each corresponding to one of the plurality of first application programs, based on the first user ID in a case where it is determined that the one or more occupants are only the first user; and
   displaying, on the display, a plurality of second icons each corresponding to one of the plurality of second application programs, based on the second user ID in a case where it is determined that the one or more occupants are only the second user.

According to the above disclosure, in a case where a plurality of people uses terminals, according to a user who is currently using the terminal, an application program used by the user can be displayed on the terminal, so that it is possible to realize an information providing system with high operability regardless of the user.

(Item 16)

The control method according to item 15, in which
the first terminal manages first secret setting information indicating a secret application program to be kept secret from a user other than the first user among the plurality of first application programs in association with the first user ID, and
the control method further includes
   displaying, on the display, one or more first icons each corresponding to one of one or more first application programs, excluding the secret application program, among the plurality of first application programs based on the first user ID and the first secret setting information in a case where it is determined that the one or more occupants include the first user and the second user.

According to the above disclosure, when a different user is in the vehicle, the user who uses the terminal can keep the use of a specific application secret from the different user, so that it is possible to realize an information providing system with high operability for the user while considering privacy.

(Item 17)

The control method according to any one of items 14 to 16, in which
the first terminal stores a plurality of first application programs that is available to the first user,
the first terminal manages usage condition information indicating whether each of the plurality of first application programs is available while the first vehicle is traveling in automatic driving at a specific level, and
the control method further includes:
   recognizing a level of automatic driving executed by the first vehicle via at least one sensor provided in the first vehicle; and
   in a case where the first vehicle is performing automatic driving at a first level, selectably displaying, on the display, only one or more first icons corresponding to one or more first application programs available during automatic driving travel at the first level, among the plurality of first application programs, based on the usage condition information.

According to the above disclosure, the user who uses the terminal connected to the vehicle can smoothly search for an installed desired application that is available according to the level of the automatic driving currently being executed in the vehicle, so that it is possible to realize an information providing system with high operability for the user.

(Item 18)

The control method according to item 17, in which
an icon corresponding to an application program other than the one or more first application programs among the plurality of first application programs is not displayed on the display.

(Item 19)

The control method according to any one of items 14 to 18, in which
the first terminal manages a plurality of application programs and usage condition information indicating an availability condition for each of the plurality of application programs, and
the control method further includes:
   acquiring occupant state information indicating a state of one or more occupants in the first vehicle via at least one first sensor provided in a vehicle compartment of the first vehicle;
   acquiring traveling state information indicating a current traveling state of the first vehicle via at least one second sensor provided in the first vehicle; and
   executing following (A) to (C) based on the occupant state information, the traveling state information, and the usage condition information,
(A) identifying one or more first application programs available to a first user among the one or more occupants among the plurality of application programs,
(B) in a case where the first user is a driver of the first vehicle,
   (b1) unselectably displaying or not displaying, to the first user, at least one first icon corresponding to at least one application program of the one or more first application programs while the first vehicle is traveling in automatic driving at a level lower than a specific level or while the first vehicle is traveling in manual driving,
   (b2) selectably displaying the at least one first icon to the first user while the first vehicle is traveling in automatic driving at a level equal to or higher than the specific level or while the first vehicle is stopped, and
(C) in a case where the first user is a passenger other than the driver,
   (c1) selectably displaying the at least one first icon to the first user while the first vehicle is traveling in automatic driving or manual driving, or stopped.

According to the above disclosure, availability of the application is determined in consideration of whether the user who uses the terminal is a driver, whether automatic driving is executed at a predetermined level of automatic driving or higher, and the like, so that it is possible to realize an information providing system with high operability for the user while considering driving safety.

(Item 20)

The control method according to any one of items 14 to 19, in which
the first terminal manages, a plurality of user IDs for identifying a plurality of a user, relationship information indicating a relationship between the plurality of user IDs, a plurality of application programs, and usage condition information indicating an availability condition for each of the plurality of application programs, and
the control method further includes:
   identifying one or more user IDs corresponding to one or more occupants in a vehicle compartment of the first vehicle via at least one first sensor provided in the vehicle compartment of the first vehicle;
   in a case where access to the first terminal by a first user ID among the one or more user IDs is accepted, identifying a plurality of first application programs that are available to the first user ID among the plurality of application programs based on the first user ID;
   acquiring traveling state information indicating a current traveling state of the first vehicle via at least one second sensor provided in the first vehicle; and
   in a case where the first vehicle is traveling in automatic driving at a level lower than a specific level based on the traveling state information, or
   in a case where the first vehicle is traveling in manual driving and it is determined, via the at least one first sensor, that the first user corresponding to the first user ID is a driver,
executing following (i) to (iv) for a specific application program among the plurality of first application programs,
(i) restricting access to the specific application program by the first user,
(ii) in a case where there is a second user ID having a predetermined relationship with the first user ID among the one or more user IDs, based on the relationship information, permitting access to the specific application program by a first passenger corresponding to the second user ID,
(iii) in a case where there is a third user ID that does not have the predetermined relationship with the first user ID among the one or more user IDs, based on the relationship information, prohibiting access to the specific application program by a second passenger corresponding to the third user ID, and
(iv) in a case where there is a third passenger who does not correspond to any of the plurality of user IDs among the one or more occupants, prohibiting access to the specific application program by the third passenger.

According to the above disclosure, availability of the application is determined in consideration of whether the user who uses the terminal is a driver, whether automatic driving is being executed at a predetermined automatic driving level or higher, whether a person having a predetermined relationship with the user is riding together, or the like, so that it is possible to realize an information providing system having high operability for the user while considering driving safety and a reliability relationship with passengers.

(Item 21)

A control method for a computer capable of communicating with a plurality of terminals via a network, the control method including:
managing a plurality of user IDs for identifying a plurality of users and a plurality of application programs in a database;
acquiring, from a first terminal, a first user ID for identifying a first user and a first terminal ID for identifying the first terminal;
when it is determined, based on the first terminal ID, that the first terminal is not an in-vehicle terminal,
   identifying a plurality of first application programs available by the first user ID with reference to the database;
   transmitting, to the first terminal via the network, first display information for displaying a plurality of first icons corresponding to the plurality of identified first application programs on the first terminal;
when it is determined, based on the first terminal ID, that the first terminal is an in-vehicle terminal connected to a first vehicle,
   narrowing the plurality of first application programs available by the first user ID down to at least one first application program available in the in-vehicle terminal, with reference to the database; and
   transmitting, to the first terminal via the network, first display information for displaying at least one first icon corresponding to the narrowed at least one first application program on the first terminal.

(Item 22A)

A control method for a first terminal connected to a first vehicle, in which
the first terminal manages a first user ID that identifies the first user and a plurality of first application programs available to the first user in association with each other, and manages a second user ID that identifies a second user different from the first user and a plurality of second application programs available to the second user in association with each other, and
the control method includes:
identifying one or more occupants in a vehicle compartment of the first vehicle via a sensor provided in the vehicle compartment of the first vehicle;
displaying a plurality of first icons corresponding to the plurality of first application programs on the display based on the first user ID in a case where it is determined that the one or more occupants are only the first user; and
displaying, on the display of the first terminal, a plurality of second icons corresponding to the plurality of second application programs based on the second user ID in a case where it is determined that the one or more occupants are only the second user.

(Item 22B)

The control method according to item 22A, in which
the first terminal manages first secret setting information indicating a secret application program to be kept secret from a user other than the first user among the plurality of first application programs in association with the first user ID, and
the control method further includes
   displaying, on the display, one or more first icons corresponding to one or more first application programs, excluding the secret application program, among the plurality of first application programs based on the first user ID and the first secret setting information in a case where it is determined that the one or more occupants include the first user and the second user.

(Item 23)

A control method for a first terminal connected to a first vehicle, the control method including:
managing a plurality of application programs and usage condition information indicating whether each of the plurality of application programs is available while the first vehicle is traveling in automatic driving at a predetermined level;
recognizing a level of automatic driving executed by the first vehicle via at least one sensor provided in the first vehicle;
in a case where the first vehicle is executing automatic driving at the first level, identifying one or more application programs available during automatic driving travel at the first level among the plurality of application programs, based on the usage condition information; and
selectably displaying, on a display of the first terminal, only one or more icons corresponding to the one or more application programs.

(Item 24)

A control method for a first terminal connected to a first vehicle, the control method including:
managing a plurality of application programs and usage condition information indicating an availability condition for each of the plurality of application programs;
acquiring occupant state information indicating a state of one or more occupants in the first vehicle via at least one first sensor provided in a vehicle compartment of the first vehicle;
acquiring traveling state information indicating a current traveling state of the first vehicle via at least one second sensor provided in the first vehicle; and
executing the following (A) to (C) based on the occupant state information, the traveling state information, and the usage condition information,
(A) identifying one or more first application programs available to a first user among the one or more occupants among the plurality of application programs,
(B) in a case where the first user is a driver of the first vehicle,
   (b1) unselectably displaying or not displaying at least one first icon corresponding to at least one application program of the one or more first application programs to the first user while the first vehicle is traveling in automatic driving at a level lower than a specific level or while the first vehicle is traveling in manual driving, and
   (b2) selectably displaying the at least one first icon to the first user while the first vehicle is traveling in automatic driving at a level equal to or higher than the specific level or while the first vehicle is stopped, and
(C) in a case where the first user is a passenger other than the driver,
   (c1) selectably displaying the at least one first icon to the first user while the first vehicle is traveling in automatic driving or manual driving, or while the first vehicle is stopped.

(Item 25) A control method for a first terminal connected to a first vehicle, the control method including:
managing a plurality of user IDs for identifying a plurality of users, relationship information indicating a relationship between the plurality of user IDs, a plurality of application programs, and usage condition information indicating an availability condition for each of the plurality of application programs;
identifying one or more user IDs corresponding to one or more occupants in the vehicle compartment of the first vehicle via at least one first sensor provided in the vehicle compartment of the first vehicle, in a case where access to the first terminal by a first user ID among the one or more user IDs is accepted;
identifying a plurality of first application programs that is available to the first user ID among the plurality of application programs based on the first user ID;
acquiring traveling state information indicating a current traveling state of the first vehicle via at least one second sensor provided in the first vehicle; and
in a case where the first vehicle is traveling in automatic driving at a level lower than a specific level based on the traveling state information, or
in a case where the first vehicle is traveling in manual driving and it is determined via the at least one first sensor that the first user corresponding to the first user ID is a driver,
executing the following (i) to (iv) for a specific application program among the plurality of first application programs,
(i) restricting access to the specific application program by the first user,
(ii) in a case where there is a second user ID having a predetermined relationship with the first user ID based on the relationship information among the one or more user IDs, permitting access to the specific application program by a first passenger corresponding to the second user ID,
(iii) in a case where there is a third user ID that does not have the predetermined relationship with the first user ID based on the relationship information among the one or more user IDs, prohibiting access to the specific application program by a second passenger corresponding to the third user ID, and
(iv) in a case where there is a third passenger who does not correspond to any of the plurality of user IDs among the one or more occupants, prohibiting the third passenger from accessing the specific application program.

(Item 26)

A program for causing a computer of the system to execute the control method according to any one of items 1 to 8.

(Item 27)

A program for causing a computer of the first terminal to execute the control method according to any one of items 9 to 20.

(Item 28)

A program for causing the computer to execute the control method according to item 21.

(Item 29)

A program for causing a computer of the first terminal to execute the control method according to any one of items 22 to 25.

(Item 30)

A recording medium (Computer Program Product) recording a program executed by a computer, the program according to any one of Items 26 to 29.

(Item 31)

A terminal that is the first terminal executing the control method according to any one of Items 9 to 20 and 22 to 25.

(Item 32)

A terminal that is the first terminal including at least one processor, the at least one processor being configured to execute the control method according to any one of Items 9 to 20 and 22 to 25.

According to the present disclosure, it is possible to further improve installation of an application on an in-vehicle terminal.

While certain embodiments have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A control method in a system that is communicable with a plurality of terminals via a network and manages a plurality of application candidates for the plurality of terminals, the control method comprising:
acquiring, via the network, from a first terminal connected to a first vehicle, first request information for requesting first catalog information indicating an application catalog for the first terminal and first level information indicating a level of automatic driving executable by the first vehicle;
generating, as the first catalog information, information including one or more first application candidates selected from the plurality of application candidates according to the level of automatic driving executable by the first vehicle, based on the first request information and the first level information; and
transmitting, to the first terminal via the network, first display information for displaying the first catalog information on a display of the first terminal.

2. The control method according to claim 1, wherein
each of the one or more first application candidates is an application candidate available when the first vehicle is traveling at a level equal to or lower than a highest level of automatic driving executable by the first vehicle or when the first vehicle is stopped.

3. The control method according to claim 1, further comprising:
acquiring, via the network, from a second terminal connected to a second vehicle, second request information for requesting second catalog information indicating an application catalog for the second terminal and second level information indicating a level of automatic driving executable by the second vehicle;
generating, as the second catalog information, information including one or more second application candidates selected from the plurality of application candidates according to the level of automatic driving executable by the second vehicle, based on the second request information and the second level information; and
transmitting, to the second terminal via the network, second display information for displaying the second catalog information on a display of the second terminal, wherein
the one or more first application candidates and the one or more second application candidates are at least partially different from each other in a case where a highest level of automatic driving executable by the first vehicle is different from a highest level of automatic driving executable by the second vehicle.

4. The control method according to claim 3, further comprising:
acquiring, via the network, from a third terminal that is not connected to the first vehicle and the second vehicle, third request information for requesting third catalog information indicating an application catalog for the third terminal and type information indicating a type of the third terminal;
generating, as the third catalog information, information including one or more third application candidates selected from the plurality of application candidates according to the type of the third terminal, based on the third request information and the type information; and
transmitting, to the third terminal via the network, third display information for displaying the third catalog information on a display of the third terminal, wherein
the one or more third application candidates are at least partially different from the one or more first application candidates and the one or more second application candidates.

5. The control method according to claim 1, wherein
in a case where the first vehicle is capable of performing automatic driving at a plurality of levels, the first display information includes information for classifying the one or more first application candidates into a plurality of groups corresponding to the plurality of levels and displaying the one or more first application candidates on the display.

6. The control method according to claim 1, wherein
the first display information includes, for a first application program corresponding to at least one of the one or more first application candidates, information indicating whether the first application program is available when the automatic driving is being executed at a first level.

7. The control method according to claim 1, wherein
the first request information includes a user ID for identifying a user of the first vehicle,
the control method further comprises
acquiring, via the network, a list of applications used by the user in a different terminal different from the first terminal from a database that manages a usage status of a plurality of applications in the plurality of terminals, based on the user ID,
in the generating of the first catalog information, at least one application candidate corresponding to at least one application used by the user in the different terminal is identified from the one or more first application candidates, based on the list, and
the first display information includes information for displaying, on the display of the first terminal, the identified at least one application candidate with priority over another application candidate.

8. The control method according to claim 1, further comprising
in a case where selection information indicating that a specific application candidate of the one or more first application candidates is selected in the first terminal is received, transmitting an application program corresponding to the specific application candidate to the first terminal via the network.

9. A control method for a first terminal that is communicable with a computer that manages a plurality of application candidates via a network and is connected to a first vehicle, the control method comprising:
transmitting, to the computer via the network, first request information for requesting first catalog information indicating an application catalog for the first terminal and first level information indicating a level of automatic driving executable by the first vehicle;
acquiring, from the computer via the network, first display information for displaying, on a display of the first terminal, the first catalog information including one or more first application candidates, the one or more application candidates being selected from the plurality of application candidates in the computer according to the level of automatic driving executable by the first vehicle, based on the first level information; and
displaying the first catalog information on the display of the first terminal, based on the first display information.

10. The control method according to claim 9, wherein
each of the one or more first application candidates is an application candidate available when the first vehicle is traveling at a level equal to or lower than a highest level of automatic driving executable by the first vehicle or when the first vehicle is stopped.

11. The control method according to claim 9, wherein
in a case where the first vehicle is capable of executing automatic driving at a plurality of levels, in the displaying of the first catalog information, classifying the one or more first application candidates are classified into a plurality of groups corresponding to a plurality of levels and displayed on the display.

12. The control method according to claim 9, wherein
in the displaying of the first catalog information, for a first application program corresponding to at least one of the one or more first application candidates, information indicating whether the first application program is available when the automatic driving is executed at a first level is displayed on the display.

13. The control method according to claim 9, wherein
the first request information includes a user ID for identifying a user of the first vehicle, and
in the displaying of the first catalog information, at least one application candidate of the one or more first application candidates is displayed on the display with priority over another application candidate, the at least one application candidate corresponding to at least one application used by the user identified based on the user ID in a different terminal different from the first terminal.

14. The control method according to claim 9, further comprising:
identifying, via input to the first terminal by a first user of the first terminal, an application candidate selected by the first user from the one or more first application candidates;
transmitting, to the computer via the network, application request information for requesting download of an application program corresponding to the identified application candidate;
receiving the application program from the computer via the network; and
installing the received application program on the first terminal.

15. The control method according to claim 14, wherein
the first terminal manages a first user ID that identifies the first user and a plurality of first application programs available to the first user in association with each other, and manages a second user ID that identifies a second user different from the first user and a plurality of second application programs available to the second user in association with each other, and
the control method further comprises:
identifying one or more occupants in a vehicle compartment of the first vehicle via a sensor provided in the vehicle compartment of the first vehicle;
displaying, on the display, a plurality of first icons each corresponding to one of the plurality of first application programs, based on the first user ID in a case where it is determined that the one or more occupants are only the first user; and
displaying, on the display, a plurality of second icons each corresponding to one of the plurality of second application programs, based on the second user ID in a case where it is determined that the one or more occupants are only the second user.

16. The control method according to claim 15, wherein
the first terminal manages first secret setting information indicating a secret application program to be kept secret from a user other than the first user among the plurality of first application programs in association with the first user ID, and
the control method further comprises
displaying, on the display, one or more first icons each corresponding to one of one or more first application programs, excluding the secret application program, among the plurality of first application programs, based on the first user ID and the first secret setting information in a case where it is determined that the one or more occupants include the first user and the second user.

17. The control method according to claim 14, wherein
the first terminal stores a plurality of first application programs that is available to the first user,
the first terminal manages usage condition information indicating whether each of the plurality of first application programs is available while the first vehicle is traveling in automatic driving at a specific level, and
the control method further comprises:
recognizing a level of automatic driving executed by the first vehicle via at least one sensor provided in the first vehicle; and
in a case where the first vehicle is performing automatic driving at a first level, selectably displaying, on the display, only one or more first icons corresponding to one or more first application programs available during automatic driving travel at the first level among the plurality of first application programs, based on the usage condition information.

18. The control method according to claim 17, wherein
an icon corresponding to an application program other than the one or more first application programs among the plurality of first application programs is note displayed on the display.

19. The control method according to claim 14, wherein
the first terminal manages a plurality of application programs and usage condition information indicating an availability condition for each of the plurality of application programs, and
the control method further comprises:
acquiring occupant state information indicating a state of one or more occupants in the first vehicle via at least one first sensor provided in a vehicle compartment of the first vehicle;
acquiring traveling state information indicating a current traveling state of the first vehicle via at least one second sensor provided in the first vehicle; and
based on the occupant state information, the traveling state information, and the usage condition information,
identifying one or more first application programs available to a first user among the one or more occupants among the plurality of application programs,
in a case where the first user is a driver of the first vehicle,
unselectably displaying or not displaying, to the first user, at least one first icon corresponding to at least one application program of the one or more first application programs while the first vehicle is traveling in automatic driving at a level lower than a specific level or while the first vehicle is traveling in manual driving,
selectably displaying the at least one first icon to the first user while the first vehicle is traveling in automatic driving at a level equal to or higher than the specific level or while the first vehicle is stopped, and
in a case where the first user is a passenger other than the driver,
selectably displaying the at least one first icon to the first user while the first vehicle is traveling in automatic driving or manual driving, or stopped.

20. The control method according to claim 14, wherein
the first terminal manages a plurality of user IDs for identifying a plurality of a user, relationship information indicating a relationship between the plurality of user IDs, a plurality of application programs, and usage condition information indicating an availability condition for each of the plurality of application programs, and
the control method further comprises:
identifying one or more user IDs corresponding to one or more occupants in a vehicle compartment of the first vehicle via at least one first sensor provided in the vehicle compartment of the first vehicle;
in a case where access to the first terminal by a first user ID among the one or more user IDs is accepted, identifying a plurality of first application programs that are available to the first user ID among the plurality of application programs, based on the first user ID;
acquiring traveling state information indicating a current traveling state of the first vehicle via at least one second sensor provided in the first vehicle; and
in a case where the first vehicle is traveling in automatic driving at a level lower than a specific level, based on the traveling state information, or
in a case where the first vehicle is traveling in manual driving and it is determined, via the at least one first sensor, that the first user corresponding to the first user ID is a driver,
for a specific application program among the plurality of first application programs,
restricting access to the specific application program by the first user,
in a case where there is a second user ID having a predetermined relationship with the first user ID among the one or more user IDs, based on the relationship information, permitting access to the specific application program by a first passenger corresponding to the second user ID,
in a case where there is a third user ID that does not have the predetermined relationship with the first user ID among the one or more user IDs, based on the relationship information, prohibiting access to the specific application program by a second passenger corresponding to the third user ID, and
in a case where there is a third passenger who does not correspond to any of the plurality of user IDs among the one or more occupants, prohibiting access to the specific application program by the third passenger.
